(19) United States
(12) Patent Application Publication
(10) Pub. No.: US 2026/0186118 A1
(43) Pub. Date: Jul. 2, 2026

(54) EXTENDED IMAGING METHODS AND SYSTEMS

(71) Applicant: WUHAN UNITED IMAGING HEALTHCARE CO., LTD., Wuhan (CN)

(72) Inventors: Cheng HE, Wuhan (CN); Lufu XIA, Wuhan (CN); Aiwei SHI, Wuhan (CN)

(73) Assignee: WUHAN UNITED IMAGING HEALTHCARE CO., LTD., Wuhan (CN)

(21) Appl. No.: 19/438,500

(22) Filed: Dec. 31, 2025

(30) Foreign Application Priority Data
Dec. 31, 2024 (CN) 202411997480.3

(51) Int. Cl. G01S 7/62; G01S 7/524; G01S 7/527; G01S 7/53

(52) U.S. Cl. CPC G01S 7/629; G01S 7/524; G01S 7/527; G01S 7/53; G01S 7/6281

(57) ABSTRACT

Embodiments of the present disclosure provide an extended imaging method and system. The method includes receiving echo signals, wherein the echo signals include first echo signals and second echo signals; for each second echo signal of at least a portion of the second echo signals, determining a display mode based on a corresponding data position of the second echo signal, the data position being a projection position of the second echo signal on a plane perpendicular to an axial direction, wherein the axial direction is a direction in which the ultrasonic probe extends into a detection site of a subject; and displaying, based on the display mode corresponding to each of at least portion of the second echo signals, one or more ultrasonic images generated based on the at least portion of the second echo signals.

### CROSS-REFERENCE TO RELATED APPLICATIONS

This application claims priority to the Chinese Patent Application No. 202411997480.3, filed on Dec. 31, 2024, the contents of which are hereby incorporated by reference.

### TECHNICAL FIELD

The present disclosure relates to a field of medical imaging, and in particular to an extended imaging method and system.

### BACKGROUND

An ultrasonic device is typically configured to scan an object to be inspected (e.g., a part of a patient's body) for diagnostic imaging. An ultrasonic probe is an important component of the ultrasonic device. There are various types of ultrasonic probes for different clinical applications. For example, an intracavitary probe is an ultrasonic probe that can be inserted into a cavity of a human organ, e.g., for trans anal rectal, transvaginal, or transesophageal examination.

Therefore, it is desirable to provide an extended imaging method and system that simultaneously enables real-time observation of cross-sections of two orthogonal planes of a detection site of a subject while expanding an imaging field of view and reducing interference from dark areas.

### SUMMARY

One or more embodiments of the present disclosure provide an extended imaging method. The method includes: receiving echo signals, the echo signals include first echo signals and second echo signals, the first echo signals are generated based on ultrasonic waves transmitted by elements on a linear array of an ultrasonic probe, and the second echo signals are generated based on ultrasonic waves transmitted by elements of two convex arrays of the ultrasonic probe

The method also includes, for each second echo signal of at least a portion of the second echo signals, determining a display mode based on a corresponding data position of the second echo signal, the data position being a projection position of the second echo signal on a plane perpendicular to an axial direction, wherein the axial direction is a direction in which the ultrasonic probe extends into a detection site of a subject.

The method further includes displaying, based on the display mode corresponding to each of at least portion of the second echo signals, one or more ultrasonic images generated based on the at least portion of the second echo signals.

The method further includes that the two convex arrays are located on two sides of the linear array, that the elements on the linear array are distributed along the axial direction while the elements on the convex arrays are distributed along a direction perpendicular to the axial direction, and that the projection of each convex array on a plane perpendicular to the axial direction is a first arc.

The method further includes simultaneously displaying a first ultrasonic image and the second ultrasonic image. The first ultrasonic image is generated based on at least one of the first echo signals. The second ultrasonic image is generated based on at least one of the second echo signals corresponding to the second arrays.

The method further includes enabling the first ultrasonic image and the second ultrasonic image to synchronously reflect a slice of the detection site parallel to the axial direction and a slice perpendicular to the axial direction, respectively.

The method further includes, in response to determining that a data position of at least one of target echo signal in the second echo signal is located in a first region, displaying a first image corresponding to the at least one of target echo signals in a reference display mode or not displaying the first image. The target echo signal is one of the echo signals. The first region is a region adjacent to a surface of the convex arrays. The display mode includes a reference display mode and non-display.

The method further includes, in response to determining that a data position of a target echo signal in the second echo signal is located in a second region, determining a second image by fusing the target echo signal and complementary echo signals. The data positions of the complementary echo signals are the same as the data position of the target echo signal. The one or more complementary echo signals are received by the two convex arrays.

The method further includes defining the second region as at least a portion of an imaging region that is covered by the two convex arrays located on the two sides of the linear array.

The method further includes determining weights for fusing the target echo signal and the complementary echo signals. The weights are determined based on at least one of a target distance, an instantaneous signal-to-noise ratio, a sound pressure distribution, an acoustic beam angle, or a tissue attenuation coefficient of a transmit ultrasound beam corresponding to each of the target echo signal and the complementary echo signals.

The method further includes generating the second image based on the weights, the target echo signal, and the complementary echo signals.

The method further includes defining a direction of elements in each of the two convex arrays as a direction of a transmit ultrasound beam extending outward from an acoustic beam focus, the acoustic beam focus being closer to each of the t two convex arrays than to a geometric center of a first arc.

The method further includes that the acoustic beam focus is a geometric center of a third arc corresponding to each of the two convex arrays. The acoustic beam focus is located on a line connecting the geometric center of the first arc and a midpoint of the first arc. The acoustic beam focus is determined based on a first extension angle of each of the convex arrays. The first extension angle is an angle for extended imaging based on the convex array.

The method further includes in response to determining that a data position of a target echo signal is located in a first region, displaying a first image corresponding to the target echo signal in a reference display mode or not displaying the first image, wherein a projection of the first region on the plane is a region bounded by a first arc, an inner emission line, and a second arc. The inner emission line is a centerline of a projection on the plane of a transmit ultrasound beam, from the two convex arrays, that is most biased toward the linear array. The second arc is an arc located outside the first arc and defined by two convex arrays that are located on the two sides of the linear array.

The method further includes that the second arc is a projection on the plane of a virtual array determined based on the two convex arrays, a center of the second arc is a geometric center of the virtual array, and a radius of the second arc is a radius of the virtual array.

The method further includes that a line connecting the center of the second arc and a midpoint of a line connecting geometric centers of the first arcs corresponding to the two convex arrays is perpendicular to a line connecting the geometric centers of the first arcs corresponding to the two convex arrays.

The method further includes that the center of the second arc is determined based on a second extension angle, the second extension angle being an opening angle of the virtual array.

The method further includes determining whether the target echo signal is located in the first region based on a first distance between a data position of the target echo signal and a geometric center of a first arc of the convex array, a second distance between the data position and a center of a second arc, and an inner emission line corresponding to the convex array.

The method further includes in response to determining that a data position of a target echo signal in the second echo signals is in a coordinate system corresponding to the convex arrays, transforming the data position into a coordinate system corresponding to a virtual array to obtain a transformed data position.

The method further includes determining whether the target echo signal is located within a target range based on the transformed data position.

The method further includes determining that the target echo signal is invalid in response to determining that the target echo signal is not located within the target range.

The method further includes performing ultrasound imaging based on the target echo signal in response to determining that the target echo signal is located within the target range.

The method further includes, in determining whether the target echo signal is within the target range based on the transformed data position, determining a first length based on the transformed data position and a radius of a third arc of the convex array receiving the target echo signal.

The method further includes determining a second length based on a radius of a second arc corresponding to the virtual array and a focusing depth of the convex array receiving the target echo signal.

The method further includes determining that the target echo signal is within the target range when the first length is smaller than the second length.

The method further includes in response to determining that a data position of a target echo signal is located in a second region, determining a fused echo signal by fusing the target echo signal and a complementary echo signal. The data position of the complementary echo signal corresponds to the data position of the target echo signal. The complementary echo signal is received by a different convex array of the two convex arrays. A projection of the second region on the plane is determined by inner emission lines of two convex arrays and is located outside the second arc. An opening angle of the projection of the second region is determined based on a first extension angle of the convex arrays.

The method further includes displaying a second image based on the fused echo signal.

The method further includes determining a third distance between a data position of the target echo signal and a target acoustic beam focus.

The method further includes determining a fourth distance between a data position of the complementary echo signal and a complementary acoustic beam focus. The target acoustic beam focus is the focus of a transmit ultrasound beam corresponding to the target echo signal. The complementary acoustic beam focus is the focus of a transmit ultrasound beam corresponding to the complementary echo signal.

The method further includes determining weights corresponding to the target echo signal and the complementary echo signal based on the third distance and the fourth distance.

The method further includes fusing the target echo signal and the complementary echo signal based on the weights to obtain the fused data determining position coordinates and a second extension angle of the target echo signal in a coordinate system corresponding to a virtual array.

The method further includes determining a target angle based on the position coordinates of the target data in the coordinate system corresponding to the virtual array.

The method further includes determining whether the target echo signal is located in the second region based on a first extension angle, the second extension angle, and the target angle.

The method further includes determining, based on a reference number of transmit ultrasound beams and a first extension angle, extension sub-angles, each corresponding to one of different emission directions for each of the two convex arrays.

The method further includes determining, based on an acoustic beam focus corresponding to each of the at least two convex d arrays and the extension sub-angles, a first position of each element of each of the two convex arrays.

The method further includes determining, based on the extension sub-angles and the acoustic beam focus corresponding to each of the at least two convex arrays, focus coordinates of transmit ultrasound beams for the different emission directions corresponding to each of the two convex arrays.

The method further includes controlling the elements on the two convex arrays of the ultrasonic probe to transmit ultrasonic waves toward the detection site based on the first positions and the focus coordinates corresponding to each of the two convex arrays.

The method further includes for any one of the two convex arrays, determining a focusing depth corresponding to the convex array based on a radius of a third arc corresponding to the convex array and a radius of the first arc. The third arc is a virtual arc when the convex array transmits acoustic waves, and a center of the third arc is determined based on the first extension angle.

The method further includes determining the focus coordinates of the transmit ultrasound beams for the different emission directions corresponding to the convex array based on the focusing depth, the radius of the third arc, and the extension sub-angles corresponding to the convex array.

One or more embodiments of the present disclosure provide an extended imaging system. The system includes: at least one storage medium including a set of instructions; and at least one processor in communication with the at least one storage medium, wherein when executing the set of instructions, the at least one processor is directed to cause the system to perform operations including: receiving echo signals, wherein the echo signals include first echo signals and second echo signals, and the first echo signals and the second echo signals are generated based on ultrasonic waves transmitted by elements on a linear array of an ultrasonic probe and elements on two convex arrays of the ultrasonic probe, respectively; for each of the second echo signals, determining a display mode based on a corresponding data position, the data position being a projection position of the second echo signals on a plane perpendicular to an axial direction, wherein the axial direction being a direction in which the ultrasonic probe extends into a detection site of a subject; and displaying, based on the display mode corresponding to each of at least portion of the echo signals, one or more ultrasonic images generated based on the at least portion of the echo signals.

### BRIEF DESCRIPTION OF THE DRAWINGS

The present disclosure is further illustrated by way of exemplary embodiments, which are described in detail with reference to the accompanying drawings. These embodiments are non-limiting, and in these embodiments, the same reference numerals denote the same structures, wherein:

FIG. 1 is a schematic diagram illustrating an application scenario of an extended imaging system according to some embodiments of the present disclosure;

FIG. 2A is a flowchart illustrating an exemplary process for extended imaging according to some embodiments of the present disclosure;

FIG. 2B is a flowchart illustrating an exemplary process for transmitting ultrasonic waves to a detection site according to some embodiments of the present disclosure;

FIG. 3 is a schematic diagram illustrating a structure of an ultrasonic probe according to some embodiments of the present disclosure;

FIG. 4 is a schematic diagram illustrating a physical structure and imaging of a single convex array according to some embodiments of the present disclosure;

FIG. 5 is a schematic diagram illustrating positions and imaging of two convex arrays according to some embodiments of the present disclosure;

FIG. 6 is a schematic diagram illustrating a first region and a second region according to some embodiments of the present disclosure;

FIG. 7 is a schematic diagram illustrating determining whether a target echo signal is located in the first region according to some embodiments of the present disclosure;

FIG. 8A is a schematic diagram illustrating an exemplary process for establishing a coordinate system according to some embodiments of the present disclosure;

FIG. 8B is a schematic diagram illustrating the determination of whether a target echo signal is valid according to some embodiments of the present disclosure;

FIG. 9 is a schematic diagram illustrating the determination of fusion weights based on distance according to some embodiments of the present disclosure;

FIG. 10 is a schematic diagram illustrating an exemplary extended imaging system according to some embodiments of the present disclosure.

FIG. 11 is a block diagram illustrating exemplary units of an extended imaging device according to some embodiments of the present disclosure.

### DETAILED DESCRIPTION

To more clearly illustrate the technical solutions of the embodiments of the present disclosure, the accompanying drawings used in the description of the embodiments are briefly introduced below. Obviously, the accompanying drawings in the following description are merely some examples or embodiments of the present disclosure. For a person of ordinary skill in the art, without creative effort, the present disclosure may be applied to other similar scenarios based on these accompanying drawings. Unless obviously obtained from the context or the context illustrates otherwise, the same numeral in the drawings refers to the same structure or operation.

It should be understood that the terms “system”, “device”, “unit”, and/or “module” used herein are methods for distinguishing components, elements, parts, sections, or assemblies of different levels. However, if other words may achieve the same purpose, the words may be replaced by other expressions.

As shown in the present disclosure and the claims, unless the context clearly indicates an exception, the words “a”, “an”, “one”, and/or “the” are not specifically limited to the singular, and may also include the plural. Generally, the terms “include” and “contain” only indicate that clearly identified steps and elements are included, and these steps and elements do not constitute an exclusive list. A method or device may also include other steps or elements.

The present disclosure uses flowcharts to illustrate the operations performed by the system according to the embodiments of the present disclosure. It should be understood that preceding or following operations are not necessarily performed precisely in order. Instead, each step may be processed in reverse order or simultaneously. At the same time, other operations may be added to these processes, or one or more operations may be removed from these processes.

Taking intracavitary ultrasound puncture diagnosis as an example, in traditional processes, during the insertion of a probe into the cavity, positions of a puncture needle and the punctured tissue cannot be simultaneously displayed on an ultrasonic image. Doctors need to frequently move the probe to determine the positions of the punctured tissue and the puncture needle, which affects the detection efficiency. Moreover, due to the different sizes and imaging processes of ultrasonic probes in ultrasound imaging devices, the imaging field of view and range are limited. Therefore, to expand the image imaging field of view, extended imaging has been proposed. However, existing extended imaging processes are not comprehensive enough and are difficult to meet actual needs. For example, the imaging field of view is still relatively limited, and imaging dark areas affect the overall imaging quality.

Therefore, some embodiments of the present disclosure provide an extended imaging method, which involves receiving echo signals generated by ultrasonic waves transmitted from elements on a linear array of the ultrasonic probe and elements on two second arrays. For each echo signal received by the convex array, the display mode is determined based on the corresponding data position, where the data position is the projection position of the echo signal on the plane. Based on the display mode, one or more ultrasonic images generated from at least a portion of the echo signals are displayed. Through the extended imaging method, echo signals received from the linear array and convex arrays for imaging may achieve simultaneous imaging of two planes (the lateral profiles and longitudinal profiles of the detection site of a subject). The simultaneous display of these two planes may collaboratively improve puncture accuracy, and by utilizing the extended imaging technique, the lateral field of view corresponding to the convex array is expanded. Additionally, by determining the display mode based on the data position of the echo signal and displaying the ultrasonic image based on the display mode, the processing method may effectively reduce image dark areas caused by interference during entry, thereby enhancing the image quality of the region jointly covered by the convex arrays.

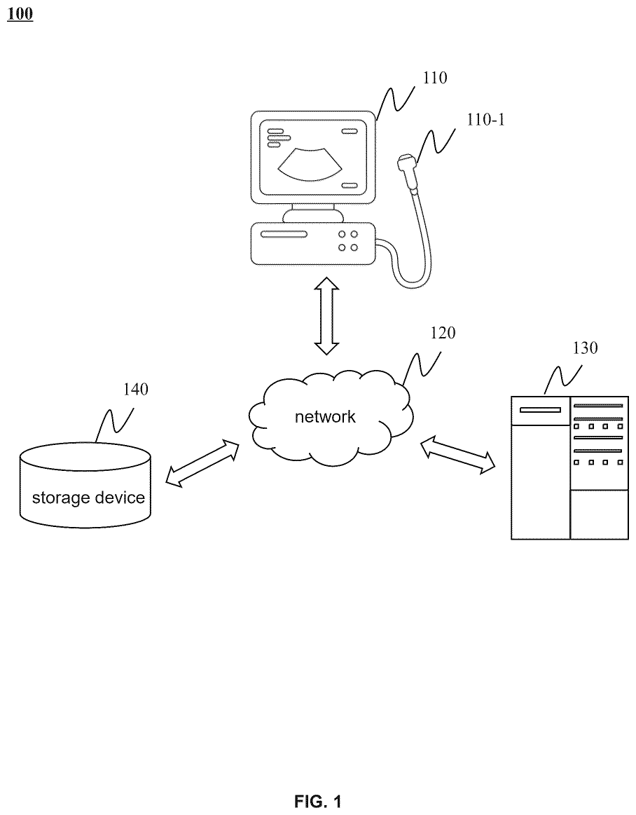

FIG. 1 is a schematic diagram illustrating an application scenario of an extended imaging system according to some embodiments of the present disclosure.

In some embodiments, as shown in FIG. 1, an application scenario 100 of the extended imaging system may include an ultrasound imaging device 110, a network 120, a processor 130, and a storage device 140. Merely by way of example, as shown in FIG. 1, the ultrasound imaging device 110 may be connected to the processor 130 via the network 120. The storage device 140 may be directly connected to the processor 130 or connected via the network 120.

The ultrasound imaging device 110 is a medical instrument that uses high-frequency sound waves to generate real-time images of internal tissues and organs of a subject (e.g., a human body). In some embodiments, the ultrasound imaging device 110 includes a main unit, a display, and a control panel. The main unit is configured with a processing unit, software, and an electronic system, and is responsible for processing data and generating ultrasonic images. The display is configured to display the generated the ultrasonic images in real time. The control panel is configured for the user to perform operations such as adjusting an imaging setting, controlling a ultrasound measurements of a detection site, and storing the ultrasonic images.

In some embodiments, the ultrasound imaging device includes an ultrasonic probe 110-1. The ultrasonic probe 110-1 is configured to perform ultrasound imaging on the detection site to obtain an ultrasonic image of the detection site. For example, the ultrasonic probe may be inserted into the interior of a biological body and obtain ultrasonic images of tissues and organs inside the biological body by transmitting ultrasonic waves.

In some embodiments, the ultrasonic probe 110-1 may include a linear array and convex arrays.

In some embodiments, the linear array refers to a linear array composed of a plurality of elements. The elements on the linear array are distributed along the direction in which the ultrasonic probe is inserted into the detection site (defined as the axial direction of the ultrasonic probe). The linear array may perform longitudinal imaging (parallel to the axial direction) on the detection site to generate a first ultrasonic image.

A convex array is a core component for performing transverse imaging (perpendicular to the axial direction) on the detection site. The count of convex arrays may be two or more, and they are set in pairs. They are symmetrically distributed on both sides of the linear array along a direction perpendicular to the axial direction. The elements on each of convex arrays are distributed along the direction perpendicular to the axial direction. The convex array may perform the transverse imaging on the detection site to generate a second ultrasonic image.

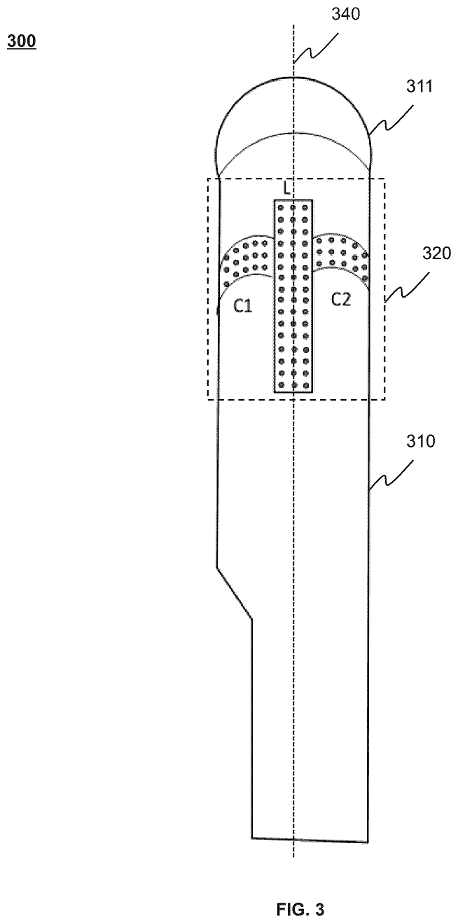

More descriptions of the ultrasonic probe may be found in FIG. 3 and related descriptions.

An ultrasonic image refers to a visual medical image generated by the ultrasound imaging device 110. In some embodiments, the ultrasonic image may include a second ultrasonic image obtained based on the convex array.

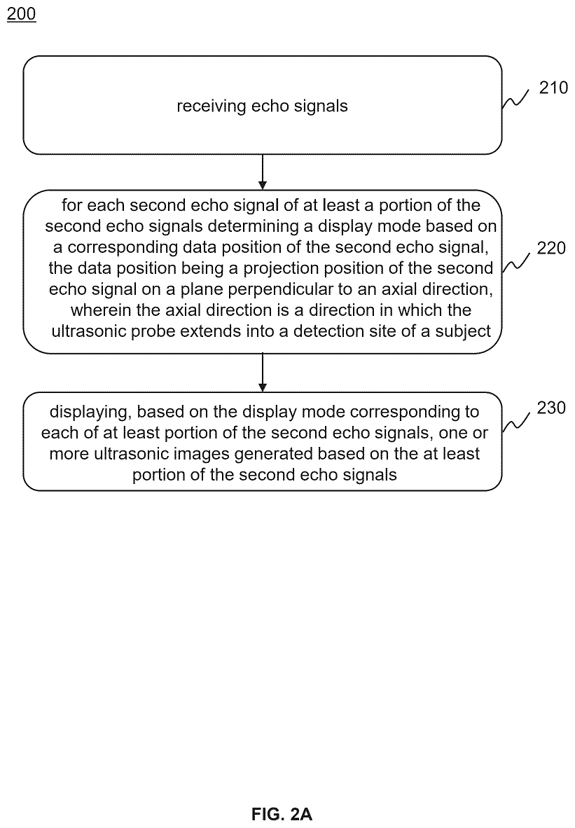

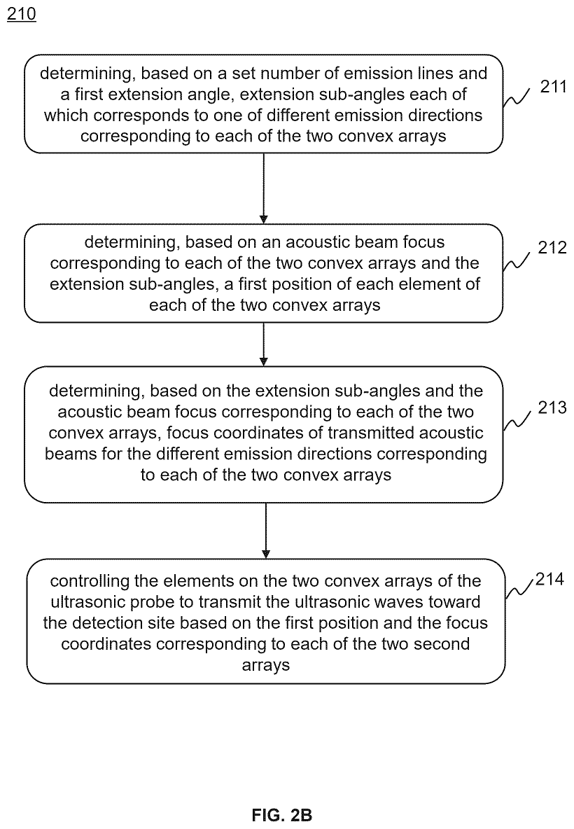

More descriptions about the second ultrasonic image may be found in FIG. 2 and related descriptions.

The network 120 may include any suitable network that facilitates the exchange of information and/or data in the application scenario 100. In some embodiments, one or more components of the application scenario 100 (e.g., the ultrasound imaging device 110, the processor 130, and the storage device 140) may transmit information and/or data to one or more other components of the application scenario 100 via the network 120. For example, the processor 130 may obtain ultrasound data from the ultrasound imaging device 110 via the network 120.

In some embodiments, the network 120 may be any one or more of a wired network or a wireless network. In some embodiments, the network may be point-to-point, shared, centralized, or various other topologies, or a combination of multiple topologies.

The processor 130 may process data and/or information obtained from the ultrasound imaging device 110 and/or the storage device 140. For example, the processor 130 may receive echo signals. The echo signals include first echo signals and second echo signals. For each of the second echo signals, the processor 130 may determine a display mode based on a corresponding data position. The processor 130 may display, based on the display mode corresponding to each of at least portion of the echo signals, one or more ultrasonic images generated based on the at least portion of the echo signals.

In some embodiments, the processor 130 may be a single server or a server group. The server group may be centralized or distributed. In some embodiments, the processor 130 may be local or remote. The processor 130 may be directly connected to the ultrasound imaging device 110 and the storage device 140 to access stored or obtained information and/or data. In some embodiments, the processor 130 may be implemented on a cloud platform. Merely by way of example, the cloud platform may include a private cloud, a public cloud, a hybrid cloud, a community cloud, a distributed cloud, an internal cloud, a multi-layer cloud, or the like, or any combination thereof.

The memory 140 may store data and/or instructions. In some embodiments, the memory 140 may store data obtained from the ultrasound imaging device 110 and/or the processor 130. For example, the memory 140 may store the echo signals received by the ultrasonic probe, etc. In some embodiments, the memory 140 may also be configured to store image processing parameters, image processing results, etc. In some embodiments, the memory 140 may store data and/or instructions for the processor 130 to execute the exemplary methods described in the present disclosure.

In some embodiments, the memory 140 may include a mass storage, a removable storage, a volatile read-write memory, a read-only memory (ROM), or the like, or any combination thereof. In some embodiments, the memory 150 may be implemented on a cloud platform.

In some embodiments, the memory 140 may be connected to the network 120 to communicate with one or more components of the application scenario 100 (e.g., the ultrasound imaging device 110, the processor 130, etc.). The one or more components of the application scenario 100 may access the data or instructions stored in the memory 140 via the network 120. In some embodiments, the memory 140 may be directly connected to or communicate with the one or more components of the application scenario 100. In some embodiments, the memory 140 may be part of the processor 130.

It should be noted that the application scenario 100 is provided for illustrative purposes only and is not intended to limit the scope of the present disclosure. For those of ordinary skill in the art, various modifications or changes may be made according to the description of the present disclosure. For example, the processor 130 and the memory 140 may be part of the ultrasound imaging device 110. However, these changes and modifications do not depart from the scope of the present disclosure.

FIG. 2A is a flowchart illustrating an exemplary process for extended imaging according to some embodiments of the present disclosure. As shown in FIG. 2A, a process 200 includes the following operations. In some embodiments, the process 200 may be executed by a processor (e.g., the processor 130).

In 210, echo signals may be obtained. In some embodiments, operation 210 may be performed by receiving module 1120.

The echo signals refer to signals that are generated by reflection of ultrasonic waves emitted by elements in an ultrasonic probe from a subject (e.g., human tissue) and are received by the same element.

An element in the ultrasonic probe refers to a minimum independent imaging unit in the ultrasonic probe for emitting and receiving the ultrasonic waves. In some embodiments, the element in the ultrasonic probe is a crystal element with a piezoelectric effect.

In some embodiments, the echo signals include first echo signals and second echo signals. The first echo signals are generated based on the ultrasonic waves transmitted by the elements on a linear array of the ultrasonic probe. The second echo signals are generated based on the ultrasonic waves transmitted by the elements on two convex arrays of the ultrasonic probe.

More descriptions of the ultrasonic probe may be found in FIG. 1 and related descriptions.

For example, FIG. 3 is a schematic diagram illustrating an exemplary ultrasonic probe according to some embodiments of the present disclosure.

In some embodiments, as shown in FIG. 3, the ultrasonic probe includes a probe body 310, one or more ultrasonic arrays 320 and an axis direction 340.

The probe body 310 refers to a main structure of the ultrasonic probe, which is a body portion for accommodating elements, electronic components, and related functional modules.

In some embodiments, the front end of the probe body 310 is provided with a detection surface 311, and the rear end of the probe body 310 may be connected to a signal emissioncable or a wireless communication module. A housing of the probe body 310 is made of a biocompatible material. The front end of the probe body refers to an end of the probe body close to a detection site of the subject, and a rear end of the probe body refers to an end of the probe body away from the detection site.

The detection surface 311 refers to a plane or curved surface at the front end of the probe body 310. The signal emissioncable refers to a wired connection cable for transmitting signals collected by the ultrasonic probe to a processor or other signal processing unit. The wireless communication module refers to a communication unit for transmitting signals collected by the ultrasonic probe to an external device in a wireless manner. The wireless manner includes, but is not limited to, Bluetooth, WiFi, etc. The housing of the probe body 311 refers to a shell that encloses an internal structure of the ultrasonic probe. The biocompatible material refers to a material that may safely contact human tissue or skin without causing irritation or harmful reactions.

In some embodiments, the one or more ultrasonic arrays include a linear array and two convex arrays located on two sides of the linear array along a direction perpendicular to the axis direction of the ultrasonic probe. As shown in FIG. 3, the ultrasonic array 320 includes a linear array L and two convex arrays C1 and C2.

In some embodiments, as shown in FIG. 3, the two convex arrays C1 and C2 are located on two sides of the linear array L, and the two convex arrays are symmetrically arranged in a direction perpendicular to the axis of the linear array L (or the axis direction of the ultrasonic probe). In some embodiments, the linear array and the two convex arrays on the two sides of the linear array are arranged to form a cross shape.

The linear array is a linear array composed of a plurality of independent elements. In some embodiments, the elements on the linear array are distributed along the axial direction of the ultrasonic probe.

The axial direction of the ultrasonic probe refers to a direction from the rear end of the ultrasonic probe to the center line of the front end of the ultrasonic probe. As shown in FIG. 3, the axial direction is the direction where the dotted line 340 is located. In some embodiments, the axial direction refers to a direction in which the ultrasonic probe extends into the detection site. In some embodiments, a center line of an arrangement of the elements of the linear array coincides with a centerline of the probe body 310 parallel to the axial direction of the ultrasonic probe.

In some embodiments, a spacing between the elements distributed along the axial direction on the linear array may be set based on actual imaging resolution requirements.

In some embodiments, the linear array is configured to obtain a longitudinal cross-sectional image of the detection site in the direction (i.e., the axis direction of the ultrasonic probe) in which the ultrasonic probe extends. The longitudinal cross-sectional image may display a depth, a thickness, and a longitudinal distribution relationship of anatomical structures in the detection site. For example, during an intraoperative ultrasound imaging, the longitudinal cross-sectional image may display the insertion trajectory of the puncture needle or the upper and lower boundaries of the organ. The detection site of the subject includes a body tissue or structure that the ultrasonic probe needs to observe or detect during an imaging process, for example, an organ, a blood vessel, a muscle, or an inserted medical instrument (e.g., a puncture needle), etc.

A convex array is an arc-shaped array including a plurality of independent array elements. In some embodiments, a curvature radius of an arc formed by the elements of a convex array may be set according to actual imaging width requirements. In some embodiments, a spacing between the elements on the convex array may be set based on actual imaging resolution requirements.

The elements of the convex array are distributed along a direction perpendicular to the axial direction.

In some embodiments, the ultrasonic probe includes the two convex arrays, and the two convex arrays are respectively located on two sides of the linear array along the direction perpendicular to the axis direction of the ultrasonic probe. In some embodiments, the count of convex arrays may also exceed two, and they are symmetrically distributed on both sides of the linear array L.

In some embodiments, a projection of each of the two convex arrays on a plane perpendicular to the axial direction is a first arc. The first arc refers to a projection shape of a physical surface and/or contour of the convex array (i.e., a convex surface formed by arrangement of the elements) on the plane perpendicular to the axial direction.

The plane perpendicular to the axial direction (also referred to as a reference plane) refers to a plane that is perpendicular to a direction in which the ultrasonic probe extends into the detection site.

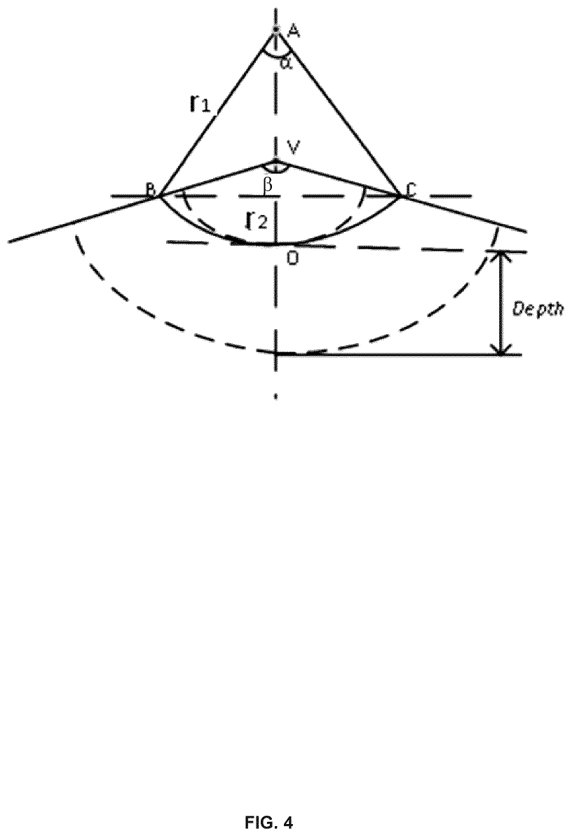

For example, FIG. 4 is a schematic diagram illustrating a physical structure and imaging of a single convex array according to some embodiments of the present disclosure.

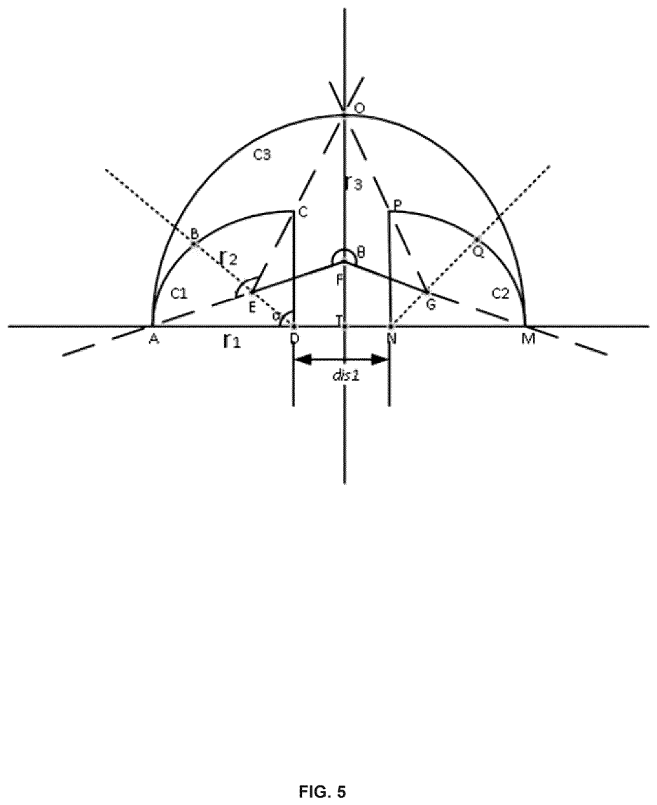

FIG. 5 is a schematic diagram illustrating positions and imaging of two convex arrays according to some embodiments of the present disclosure.

As shown in FIG. 4, an arc BOC in FIG. 4 is a first arc corresponding to a single convex array; in FIG. 5, an arc ABC and an arc PQM are first arcs corresponding to the two convex arrays respectively located on two sides of the linear array along the direction perpendicular to the axis direction of the ultrasonic probe.

In some embodiments, as shown in FIG. 4, a sector ABC is a projection of a physical structure of a single convex array and the lines connecting the left and right outer endpoints of the physical structure to the center of the physical circle on the plane (i.e., the reference plane), and the physical structure is an arc-shaped surface structure; the first arc BOC is a projection of a physical surface of the element distribution of the single convex array on the plane (i.e., the reference plane); a point A is a geometric center of the first arc, i.e., a physical center of the single convex array; r1 is a radius of the first arc and also a physical radius of the convex array; a is a physical opening angle of the convex array; β is a first extension angle for extended imaging of the convex array; a point Vis a virtual center for extended imaging of the single convex array, and is also a acoustic beam focus for extended imaging of the single convex array; VO is a virtual radius r₂ for extended imaging of the single convex array; a straight line AO is a center line of the first arc BOC; Depth is a focusing depth of ultrasonic waves emitted by the convex array.

The probe surface of the convex array (i.e., the part in contact with the patient) is an arc-shaped (circular arc) surface. This is the most distinctive appearance feature of the convex array. The core components inside the convex array responsible for transmitting and receiving ultrasonic waves—the elements—are arranged along an arc-shaped curved surface (i.e., the convex surface). When performing convex array imaging, after the sound waves are emitted from the surface of the arc-shaped curved surface, a two-dimensional imaging section of a fan shape is naturally formed.

After the convex array is installed and configured, the surface of the convex array presents an arc-shaped surface. The physical center refers to a center of a surface arc of the convex array, the physical radius refers to a radius of the surface arc of the convex array. The physical opening angle refers to an angle of the central angle corresponding to the surface arc of the convex array. The first extension angle refers to an angle for extended imaging of a single convex array (e.g., an included angle between two outermost ultrasonic beams in emitted ultrasonic beams of the single convex array). The virtual center for extended imaging of the single convex array refers to a convergence point of corresponding ultrasonic beams during extended imaging, i.e., the acoustic beam focus emitted by the single convex array. The virtual radius for extended imaging of the single convex array refers to a radius of a virtual arc formed during extended imaging of the single convex array.

In some embodiments, the acoustic beam focus may be determined according to the first extension angle. More descriptions may be found in formula (1) and related descriptions.

In some embodiments, for more convenient description and processing of echo signals, as shown in FIG. 4, a point O of a physical center of the convex array may be used as a coordinate origin of a first coordinate system, and AO may be used as a Z-axis of the first coordinate system. The first coordinate system is a coordinate system corresponding to the single convex array, and parameters shown in FIG. 4 may be denoted based on the first coordinate system.

In some embodiments, as shown in FIG. 5, projections of physical structures of the two convex arrays C1 and C2 symmetrically distributed on two sides of the linear array, and the lines connecting the left and right outer endpoints of the physical structures to the center of the physical circle on the plane (i.e., the reference plane) are respectively a sector ACD and a sector PMN; the first arc ABC and the first arc PQM are respectively projections of physical surfaces of the two convex arrays C1 and C2 on the plane (i.e., the reference plane); a point D and a point N are respectively geometric centers of the first arc ABC and the first arc PQM, and are also respectively physical centers of C1 and C2; r₁ (i.e., AD, MN) is a physical radius of the two convex arrays; β is a first extension angle for extended imaging of the two convex arrays; a point E and a point G are respectively virtual centers for extended imaging of the convex arrays C1 and C2, and are also respectively acoustic beam focuses for extended imaging of the convex arrays C1 and C2; r₂ (i.e., EB, GQ) are respectively radii of virtual arcs for extended imaging of the convex arrays; a straight line BD is a center line of the first arc ABC, and a straight line GQ is a center line of the first arc PQM; C3 is a virtual array formed by fusion when the two convex arrays C1 and C2 emit ultrasonic waves; a point F is a geometric center of the virtual array C3; r₃ (i.e., FO′) is a radius of the virtual array C3; an arc AOM is a projection of the virtual array C3 on the plane (i.e., the reference plane)—a second arc; θ is a second extension angle; a straight line O′F is a center line of the second arc AO′M.

In some embodiments, the virtual arc formed by extended imaging of each single convex array is defined as a third arc.

In some embodiments, for convenient description and subsequent processing of the echo signals, a second coordinate system may be established with O′ as a coordinate origin. The second coordinate system is a coordinate system corresponding to the virtual array C3 formed by the convex arrays C1 and C2 emitting the ultrasonic waves, and parameters shown in FIG. 5 may be denoted based on the second coordinate system. Parameters denoted by the first coordinate system and parameters denoted by the second coordinate system may be mutually converted according to a mathematical relationship.

For more descriptions of the acoustic beam focus, the first arc, the second arc, the third arc, etc., may be found in FIG. 2 and related descriptions.

In some embodiments, an emission direction of elements in each of the at least two convex arrays is a direction of a transmit ultrasound beam from an acoustic beam focus outward, and the acoustic beam focus is closer to the each of the two convex arrays than a geometric center of the first arc.

In some embodiments, each convex array corresponds to an acoustic beam focus, and each convex array corresponds to a first arc. The emission direction of each element in the convex array is the direction in which the acoustic beam focus corresponding to the convex array emits the sound beam outward, and the acoustic beam focus corresponding to the convex array is closer to the convex array than the geometric center of the first arc corresponding to the convex array.

The emission direction of elements in a convex array refers to a direction in which the elements of the convex array emit the ultrasonic beams outward.

The acoustic beam focus of a convex array refers to a convergence point of extension lines of the ultrasonic beams emitted by the elements of the convex array. In some embodiments, the acoustic beam focus is a virtual acoustic center, and may be determined according to a required extended imaging range or a first extension angle of extended imaging.

For example, in FIG. 5, the acoustic beam focus corresponding to the convex array C1 is the point E, and an emission direction of the elements in the convex array C1 are directions of rays EA, EB, and EC, etc.; the emission direction corresponding to the convex array C2 is the point G, and an emission direction of the elements in the convex array C2 are directions of rays GP, GQ, and GM, etc.

In some embodiments, the acoustic beam focus of a convex array is a geometric center of a third arc corresponding to the convex array. The third arc is a virtual arc when the convex array transmits acoustic waves. The acoustic beam focus of the convex array is located on a line connecting the geometric center of the first arc of the convex array and a midpoint of the first arc of the convex array. The acoustic beam focus of the convex array is determined based on a first extension angle of the convex array. The first extension angle may be an angle for extended imaging based on the convex array.

The third arc corresponding to the convex array refers to a projection of a virtual arc formed by extended imaging of a single convex array on a plane (i.e., the reference plane).

The first extension angle of the convex array refers to an angle for extended imaging of a single convex array. The first extension angle may be set manually based on demand. The extended imaging based on an array (e.g., the linear array, the convex array) refers to an imaging process that determines the angle of extended imaging, then calculates the coordinates of the elements of extended imaging and the focus coordinates of the transmit ultrasound beams of each element based on this angle, and controls the ultrasonic wave emission based on the element coordinates and focus coordinates. The extended imaging method enables a single convex array to cover a wider and more extensive area. In addition, when two paired convex arrays are respectively located on both sides of the linear array, more ultrasonic waves may be fused in the interval region of the linear array, thereby improving the imaging quality in the middle part of the convex array. In some embodiments, the extended imaging can obtain a wider field of view and more comprehensive image information.

More descriptions of determining the element coordinates and the focus coordinates of the transmit ultrasound beams in extended imaging, as well as controlling acoustic wave emission based on the element coordinates and the focus coordinates, may be found in Steps 211 to 214 and related descriptions.

In some embodiments, the acoustic beam focus of the convex array is located on a line connecting the geometric center of the first arc and the midpoint of the first arc. For example, as shown in FIG. 4, the acoustic beam focus Vis located on the connection line between the geometric center A of the first arc and the midpoint O of the first arc.

In some embodiments, the processor may determine a radius of the third arc corresponding to the convex array through a geometric relationship according to the first extension angle of the convex array, and then determine the acoustic beam focus of the convex array according to the radius of the third arc. For example, the acoustic beam focus of the convex array may be determined according to formula (1) as follows:

$${r}_{2} = {r}_{1} ( 1 - cos ( \frac{α}{2} ) ) + \frac{{r}_{1} sin ( \frac{α}{2} )}{tan ( \frac{β}{2} )} \qquad ( 1 )$$

where, r₁ is the physical radius of the convex array, a is the physical opening angle of the convex array, and r₁ and α may be obtained based on basic parameter information (e.g., factory configuration parameters and installation parameters) of the convex array; β is the first extension angle of the convex array; r₂ is the virtual radius for extended imaging of the single convex array, i.e., the radius of the third arc.

As a further example, as shown in FIG. 5, the processor may determine a point E on a line segment BD that is at a distance of r₂ from the point B as the acoustic beam focus for the extended imaging of the convex array C1, and determine a point G on the line segment QN that is at a distance of r₂ from the point Q as the acoustic beam focus for extended imaging of the convex array C2.

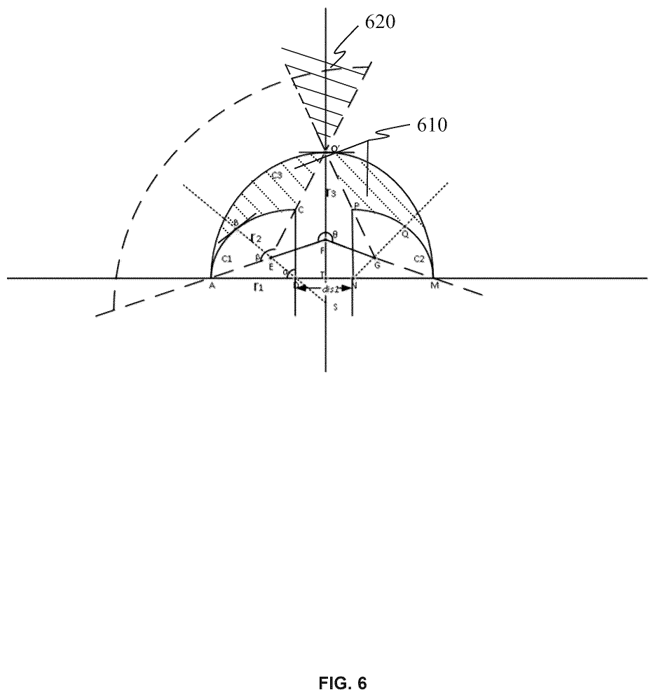

In some embodiments, the first extension angle of the convex array may be determined manually based on experience, or may be determined according to the second extension angle. More descriptions of determining the first extension angle based on the second extension angle may be found in FIG. 6 and related descriptions.

In some embodiments of the present disclosure, determining the position of the acoustic beam focus of a convex array through the first extension angle can effectively improve the accuracy of determining the acoustic beam focus, providing a reliable data foundation for subsequent processing of the echo signals.

The acoustic beam focus of a convex array is closer to the convex array than the geometric center of the first arc of the convex array. For example, as shown in FIG. 4, the acoustic beam focus V is closer to the first arc projected by the convex array on the reference plane than the geometric center A of the first arc BOC.

As another example, as shown in FIG. 5, the acoustic beam focus E of the convex array C1 is closer to the convex array C1 than the geometric center D of the first arc ABC of the convex array C1; the acoustic beam focus G of the convex array C2 is closer to the convex array C2 than the geometric center G of the first arc PQM of the convex array C2.

According to some embodiments of the present disclosure, the extension imaging method uses the first extension angle to converge the transmit ultrasound beam centers inward. This convergence causes the ultrasonic beams from the convex arrays to meet in the linear array area, thereby eliminating imaging dark areas and thus ensuring the continuity and clarity of the lateral image.

In some embodiments, parameter configuration of the ultrasonic device is required before the ultrasonic probe transmits the ultrasonic waves. The parameter configuration may include configuring an excitation frequency and an excitation voltage of the elements on the linear array to meet the resolution requirements of the intracavitary tissue. The parameter configuration may also include setting the scan angle of the convex array, the deflection angle of a near-side crystal, and the acoustic beam focus for imaging. Merely by way of example, before transmitting the ultrasonic waves, the ultrasonic probe may set the excitation frequency on the linear array to 5˜10 MHz to adapt to the resolution requirements of the intracavitary tissue; set the first extension angle for extension imaging of the convex array to 90˜120°; set the elements on the convex array close to the linear array to deflect 5˜15° towards the linear array, etc.

In some embodiments, the processor controls the ultrasonic probe to transmit the ultrasonic waves and receive the echo signals in a “synchronous emission+time-sharing reception” mode. The synchronous emission refers to controlling the linear array and the at least two convex arrays to synchronously transmit the ultrasonic waves, the linear array transmits ultrasonic waves along the axial direction, and the at least two second arrays transmit ultrasonic waves along a direction perpendicular to the axial direction based on the first extension angle. The time-sharing reception refers to configuring a plurality of time-sharing circuits, each corresponding to one or more different elements in the ultrasonic probe, by applying time-sharing settings to these time-sharing circuits, the corresponding elements are controlled to receive the echo signals at different times, thereby avoiding mutual interference during the echo signal reception.

In some embodiments, the processor may also set different time-sharing circuits for different arrays. For example, the linear array and the convex array can correspond to different time-sharing circuits. In some embodiments, the time-sharing circuits may be configured to cause the linear array to receive the longitudinal echo signal before the convex array to receive the lateral echo signal, preventing inter-array signal crosstalk.

FIG. 2B is a flowchart illustrating an exemplary process for transmitting ultrasonic waves to a detection site according to some embodiments of the present disclosure.

In some embodiments, as shown in FIG. 2B, operation 210 includes sub-operations 211-214.

In 211, based on a reference number of transmit ultrasound beams and a first extension angle, extension sub-angles each of which corresponds to one of different emission directions of each of the two convex arrays may be determined.

The reference number of transmit ultrasound beams refers to a total count of ultrasonic beams for transmitting the ultrasonic waves from the convex array preset by a user. The reference number of transmit ultrasound beams may be represented by the letter N.

An extension sub-angle corresponding to an emission direction refers to an angle corresponding to the emission direction allocated to each of the transmit ultrasound beams within the first extension angle range.

In some embodiments, for any convex array, the extension sub-angles corresponding to the different emission directions of the convex array are determined based on the positions of the elements associated with the transmit ultrasound beams. For example, an extension sub-angle corresponding to an emission direction is an angle between a line segment formed by connecting the position of the element corresponding to the emission direction and the acoustic beam focus of the convex array to which the element belongs, and a line segment formed by connecting the physical center of the convex array and the acoustic beam focus of the convex array (e.g., line segment AO in FIG. 4).

In some embodiments, the first extension angle is divided into N extension sub-angles, and the i-th extension sub-angle corresponding to the i-th transmit ultrasound beam is obtained according to formula (2), where the i-th transmit ultrasound beam is a ray corresponding to the ultrasonic beam transmitted by the i-th element. Formula (2) is as follows:

$${β}_{i} = \frac{β}{N} * i \qquad ( 2 )$$

where, βᵢ is the i-th extension sub-angle, i∈|1, N; β represents the first extension angle; N is the reference number of transmit ultrasound beams.

In 212, based on an acoustic beam focus corresponding to each of the at least two convex arrays and the extension sub-angles, a first position of each element of each of the two convex arrays may be determined.

The first position of an element refers to position coordinates of a projection of the element of one of the two convex arrays on a plane (i.e., the reference plane).

In some embodiments, the processor may determine the first position of an element of a convex array of the convex arrays based on a radius of a third arc of the convex array and the extension sub-angle corresponding to the emission direction of the element of the convex array. For example, the processor may determine the first position of an element of one of the two convex arrays according to formula (3) as follows:

$$\{ \begin{matrix}{x}_{i} = {r}_{2} sin ( {β}_{i} ) \\ {z}_{i} = {r}_{2} ( cos ( {β}_{i} ) - 1 )\end{matrix} , \qquad ( 3 )$$

where, xᵢ represents a horizontal coordinate of the i-th element on the convex array in a first coordinate system; zᵢ represents a vertical coordinate of the i-th element on the convex array in the first coordinate system, βᵢ is the i-th extension sub-angle corresponding to the i-th transmit ultrasound beam transmitted by the i-th element, (xᵢ, zᵢ) represents the first position of the i-th element.

In 213, based on the extension sub-angles and the acoustic beam focus corresponding to each of the two convex arrays, focus coordinates of transmit ultrasound beams for the different emission directions corresponding to each of the two convex arrays may be determined.

The focus coordinates refer to the position coordinates used to ensure that the transmit ultrasound beam is accurately focused on the detection site.

The detection site refers to a specific tissue region or target position that needs to be focused on, imaged, or measured in ultrasonic detection, e.g., a lesion, an organ structure, a tissue layer, or a region at a specific depth.

Based on the extension sub-angles and the acoustic beam focus corresponding to each convex array, the processor may determine the focus coordinates of the transmit ultrasound beams for each of the different emission directions corresponding to each convex array in a plurality of ways.

For example, simulation software may be used to determine the focus coordinates of the transmit ultrasound beams for each of the different emission directions corresponding to a convex array through simulation based on the extension sub-angles and the acoustic beam focus of the convex array.

In some embodiments, for any one of the two convex arrays, the processor may acquire a focusing depth corresponding to the convex array. The processor may determine the focus coordinates of the transmit ultrasound beams for the different emission directions corresponding to the convex array based on the focusing depth, the radius of the third arc, and the extension sub-angles corresponding to the convex array.

More descriptions of the third arc may be found in FIG. 4 and FIG. 5 and related descriptions.

The radius of the third arc refers to the radius of the virtual arc for the convex array to perform extension imaging, e.g., r₂ as described elsewhere in the present disclosure.

The focusing depth Depth refers to a depth of the natural focus point of the convex arrays. The focusing depth is related to the physical hardware parameters of the convex arrays. For example, the focusing depth is related to the physical radius of the convex arrays (i.e., the radius r1 of the first arc); the longer the physical radius, the deeper the focusing depth.

In some embodiments, the processor may acquire the focusing depth of the convex array through the basic parameter information of the convex array (such as factory configuration parameters, installation parameters, etc.).

In some embodiments, the processor may determine the focus coordinates of a transmit ultrasound beam for an emission direction corresponding to the convex array based on the focusing depth, the radius of the third arc, and the extension sub-angles corresponding to the convex array. For example, the focus coordinates of the transmit ultrasound beam for the emission direction corresponding to the convex array are determined by the following formula (4).

$$\{ \begin{matrix}{x}_{fi} = ( {r}_{2} + Depth ) sin ( {β}_{i} ) \\ {z}_{fi} = ( {r}_{2} + Depth ) cos ( {β}_{i} ) - {r}_{2}\end{matrix} , \qquad ( 4 )$$

where, x_{fi} is a horizontal coordinate of the focus coordinate of the i-th transmit ultrasound beam; z_{fi} is a vertical coordinate of the focus coordinate of the i-th transmit ultrasound beam; and v Bi is the i-th extension sub-angle corresponding to the i-th transmit ultrasound beam transmitted by the i-th element; r₂ refers to the radius of the third arc, and Depth refers to the focusing depth.

In some embodiments of the present disclosure, the processor calculates the focus coordinates in the respective emission directions by combining the respective extension sub-angles and the focusing depth, enabling the transmit ultrasound beam to achieve precise focusing at a set depth, reduce speckle noise, improve spatial resolution, and further enhance imaging quality and detail representation capability.

In 214, the elements on the convex arrays of the ultrasonic probe may be controlled to transmit the ultrasonic waves toward the detection site based on the first position and the focus coordinates corresponding to each of the two convex arrays.

More descriptions of the first position may be found in operation 212 and related descriptions. More descriptions of the detection site may be found in operation 213 and related descriptions.

In some embodiments, controlling the elements on the two convex arrays of the ultrasonic probe to transmit the ultrasonic waves to the detection site includes three steps: element selection, delay calculation, and emission direction control. The element selection is based on the first positions of elements associated with the convex array, in order to determine which the elements of the convex array need to be activated during the launch process. The delay calculation is based on the respective focus coordinates corresponding to each convex array to calculate the emission delay of each element, so that the transmit ultrasound beams of the plurality of the arrays are synchronized in time to form a precise focus at the focus coordinates. The emission direction control refers to controlling an emission direction of an ultrasound beam according to the respective first positions of the elements on the convex array and the corresponding focus coordinates, or the like, to ensure that the sound beam energy is effectively concentrated and a clear image is obtained.

In some embodiments of the present disclosure, the processor determines the focus coordinates in different emission directions based on the extension sub-angles corresponding to the respective emission directions of the convex array, in combination with the focusing depth. The processor then controls the transmission of acoustic beams according to the respective first positions of the elements on each convex array and the corresponding focus coordinates of the different emission directions, so that the acoustic beams transmitted by the convex array can uniformly cover the region to be detected (i.e., the detection site) of the subject, avoid imaging blind areas, improve imaging clarity and spatial resolution, and thereby enhance the structural representation capability of the detection site.

In some embodiments, the ultrasound images include a second ultrasonic image.

In some embodiments, the processor may generate the first ultrasonic image based on at least one of first echo signals.

In some embodiments, the processor may generate the second ultrasonic image based on at least one of second echo signals.

More description of the generation of the first ultrasonic image and second ultrasonic images may be found in step 230 and the related descriptions.

In 220, for each second echo signal of at least a portion of the second echo signals, determining a display mode based on a corresponding data position of the second echo signal.

The data position being a projection position of the echo signal on a plane perpendicular to the axial direction (i.e., the reference plane). More descriptions of the second echo signal may be found in step 210 and related descriptions. More descriptions of the axial direction may be found in step 210 and related descriptions.

The processor may determine the data position of the second echo signal in a plurality of ways. For example, the processor may determine a position of the detection site corresponding to the second echo signal, and then project the position of the detection site along the axial direction on the reference plane to determine the data position corresponding to the second echo signal. The processor may determine the position of the detection site corresponding to the second echo signal based on a position of the acoustic beam focus, an emission direction of an ultrasonic beam corresponding to the second echo signal, and a detection distance determined according to a time from ultrasonic beam emission to second echo signal reception.

In some embodiments, the processor may determine the data position corresponding to the second echo signal in other ways. More descriptions may be found in FIG. 6 to FIG. 9 and related descriptions.

In some embodiments, the display mode includes a reference display mode and non-display.

In some embodiments, the processor determines, based on the data position of the second echo signal, whether the second echo signal is located in a first region or a second region.

In some embodiments, in response to determining that the data position of at least one of target echo signal in the second echo signals is located in the first region, the processor may determine that a first image corresponding to the target echo signal is displayed in a reference display mode or that the first image is not displayed. The target echo signal is one of the echo signals, and the first region is a region adjacent to a surface of the convex arrays.

In some embodiments, in response to determining that the data position of the target echo signal in the second echo signal is located in the second region, the processor may determine a second image by fusing the target echo signal and one or more complementary echo signals. A complementary echo signal is an echo signal whose data position is the same as the data position of the target echo signal and is received by a different second array from the target echo signal. The second region is at least a part of an imaging region that is covered by each of two convex arrays located on both sides of the linear array.

More descriptions of the target echo signal, the first region, the second region, and determining a corresponding display mode according to the region may be found in FIG. 6 to FIG. 9 and related descriptions.

The display mode refers to a presentation form or visualization manner of an ultrasonic image corresponding to an echo signal. The display mode corresponding to the first echo signal and the second echo signal are different. For example, the display mode may include not displaying an ultrasonic image corresponding to the second echo signal, displaying the ultrasonic image in the reference display mode, displaying an ultrasonic image generated based on the second echo signal after fusion processing, etc. The reference display mode includes, but is not limited to, low-contrast display, e.g., adjusting grayscale values of pixels of a corresponding ultrasonic image to an extremely low range (such as 0-20), which is far below a normal tissue grayscale interval of 50-200. As another example, the display mode of the first echo signal includes normal display. The normal display may include global display of ultrasound images generated base on the first echo signal in accordance with conventional contrast, chromaticity, etc. The normal display may also include displaying the ultrasound images generated base on the first echo signal in a default display mode of the ultrasound imaging device.

In some embodiments, for the first echo signal, the processor determines that its display mode is the normal display.

In 230, based on the display mode corresponding to each of at least portion of the second echo signals, one or more ultrasonic images generated based on the at least portion of the second echo signals may be displayed.

In some embodiments, the processor displays an ultrasonic image generated based on at least portion of the echo signal based on the type of echo signal and its display mode.

In some embodiments, the display mode corresponding to the first echo signal is the normal display. The processor may generate the corresponding ultrasonic image based on the first echo signal and then performs normal display.

In some embodiments, the processor may determine how to display an ultrasonic image generated based on the second echo signal according to the display mode corresponding to the second echo signal. For example, if the display mode corresponding to the second echo signal is not displaying, the processor may not display the local ultrasonic image corresponding to the second echo signal on a global ultrasonic image that reflects the entire detection area. As another example, if the display mode corresponding to the second echo signal is displaying after fusion processing, the processor may perform fusion processing on the second echo signals, and then generate the ultrasonic image based on the fused signal for display.

More descriptions of displaying the ultrasonic image based on the display mode may be found in FIG. 6 to FIG. 9 and related descriptions.

In some embodiments, the one or more ultrasonic images include a second ultrasonic image. The second ultrasonic image is obtained based on the second echo signals received by the convex arrays.

In some embodiments, the processor may simultaneously display the first ultrasonic image and the second ultrasonic image.

The first ultrasonic image refers to an ultrasonic image generated based on the first echo signal received by the linear array.

In some embodiments, the processor processes the first echo signal received by the linear array to generate the first ultrasonic image. In some embodiments, the processor may perform preprocessing on at least one of the first echo signal received by the linear array, and then generate the first ultrasonic image based on the preprocessed echo signal.

The preprocessing may include, but is not limited to, filtering the first echo signal to remove high-frequency noise, amplifying the echo signal to enhance a weak signal, and correcting attenuation of echo signals at different depths through depth gain compensation, thereby outputting a standardized electrical signal.

The second ultrasonic image refers to an ultrasonic image obtained based on the second echo signal corresponding to the convex arrays.

In some embodiments, the processor may directly generate the second ultrasonic image based on at least one of echo signals received by the at least two second arrays.

In some embodiments, the processor may perform fusion processing on the second echo signals, among the second echo signals received by the two convex arrays, that are located in the second region, to obtain a fused second echo signal, and then process the fused second echo signal and other second echo signals (i.e., the second echo signals not in the second region) to generate the second ultrasonic image. In some embodiments, the second region refers to a region that is covered by the ultrasonic waves of each of two convex arrays.

In some embodiments, the processor may perform fusion processing on the second echo signals, among the second echo signals received by the two convex arrays, that are located in the second region, to obtain the fused second echo signal. Then, the processor may generate ultrasonic sub-images based on the fused second echo signal and the other second echo signals (i.e., the echo signals not in the second region) respectively, and then use an image stitching algorithm to stitch the ultrasonic sub-images to obtain the second ultrasonic image.

In some embodiments, before generating the second ultrasonic image, the processor further performs processing poor-quality second echo signals caused by near-field interference to reduce the dark areas of the image. For example, quality enhancement processing is performed on the second echo signals located in the near-field interference region. As another example, a second echo signal located in a near-field interference region is directly set to 0. The second echo signal set to 0 is invalid, and no image is generated or a corresponding image region is not displayed.

In some embodiments, the near-field interference region includes a first region. More descriptions of the first region and the second region may be found in FIG. 6 to FIG. 9 and related descriptions.

In some embodiments, the processor may simultaneously display the first ultrasonic image and the second ultrasonic image. For example, a display interface of a medical imaging device may be divided into two regions. The processor may simultaneously display the first ultrasonic image and the second ultrasonic image in different display regions. In some embodiments, the processor may also simultaneously display the first ultrasonic image and the second ultrasonic image in a same-frequency linkage display mode, so that a positional relationship of detected parts corresponding to the first ultrasonic image and the second ultrasonic image is synchronously and visually displayed. The same-frequency linkage display mode refers to the situation where, when a certain position or area in the first ultrasonic image is displayed, the corresponding position or area in the second ultrasonic image, or the same position or area, is also displayed simultaneously and synchronously.

In some embodiments, the first ultrasonic image is a slice of the detection site parallel to the axial direction and the second ultrasonic image is a slice of the detection site perpendicular to the axial direction. The first ultrasonic image and the second ultrasonic image may simultaneously reflect the sections of the detection site parallel to and perpendicular to the axial direction.

In some embodiments, the first ultrasonic image and the second ultrasonic image synchronously reflect a cross section of the detection site parallel to an axial direction and a cross section of the detection site perpendicular to the axial direction.

In some embodiments, the first ultrasonic image reflects a profile of the detected part parallel to the axial direction, e.g., a puncture needle depth trajectory, upper and lower boundaries of an organ.

In some embodiments, the second ultrasonic image synchronously reflects a profile of the detected part perpendicular to the axial direction based on the display of the first ultrasonic image. For example, left-right diameter distribution of an organ, transverse course of a blood vessel.

In some embodiments of the present disclosure, the first ultrasonic image and the second ultrasonic image synchronously reflect profiles of the detected part parallel to the axial direction and perpendicular to the axial direction. The synchronous image display achieves a three-dimensional view of “longitudinal depth+transverse range”. Meanwhile, a probe action is mapped to dual planes in real time, allowing a doctor to intuitively associate spatial positions of anatomical structures, thereby significantly improving positioning efficiency and accuracy. Furthermore, the same-frequency linkage display mode also allows the doctor to simultaneously observe the profiles of the detected part in the axial direction and perpendicular to the axial direction, which is more conducive to disease observation and treatment operations.

It should be noted that the foregoing description of process 200 is merely for illustration and explanation, and does not limit the applicable scope of the present disclosure. For those skilled in the art, various modifications and changes may be made to process 200 under the guidance of the present disclosure. However, these modifications and changes still fall within the scope of the present disclosure.

FIG. 6 is a schematic diagram illustrating a first region and a second region according to some embodiments of the present disclosure.

The processor may determine whether a second echo signal is located in the first region or the second region based on a data position of the second echo signal and then determine a display mode for an ultrasonic image corresponding to the echo signal based on different regions.

The first region 610 is a region adjacent to the surface of a convex array. The region adjacent to the surface of the convex array refers to a region with a distance from the physical surface of the second array less than a threshold (e.g., 2 nm). In some embodiments, the first region is a region where acoustic near-field interference is concentrated, mainly including interference signals such as side lobes, clutter, a plurality of reflection noises, etc., and reliability of the echo signal is low.

In some embodiments, in response to determining that a data position of a target echo signal within the second echo signals is located in the first region, the processor may display a first image corresponding to the target echo signal in a reference display mode or may not display the first image.

The target echo signal refers to the second echo signal of the area to be determined. In some embodiments, the target echo signal may be any one of the second echo signals.

The first image refers to a local ultrasonic image generated based on the echo signal.

More descriptions of the target echo signal, the reference display mode, and the first image may be found in operation 230 and related descriptions.

More descriptions of the data position and the reference display mode may be found in FIG. 2 and related descriptions.

Since the first region belongs to the near-field interference region, an ultrasonic image generated based on the second echo signal whose data position is located in the first region may have a low quality (with a dark region). Therefore, in some embodiments, when the data position of the target echo signal in the second echo signals is located in the first region, the processor displays the first image generated based on the target echo signal with low grayscale values (e.g., the gray value range is 0-20) or does not display the first image, to avoid interference to medical staff caused by the image of this region.

A projection of the first region on the plane (i.e., the reference plane) is a region bounded by the first arc, one or more inner emission lines, and a second arc. For example, as shown in FIG. 6, the first region 610 comprises two closed regions: one bounded by the first arc ABC, the inner emission line EO′, and the second arc AO′M; and the other bounded by the first arc PQM, the inner emission line PO, and the second arc AO′M.

More descriptions of the first arc may be found in operation 210 and related descriptions.

An inner emission line is a centerline of the projection on the plane (i.e., the reference plane) of a transmit ultrasound beam, from one of the two convex arrays, that is most biased toward the linear array. As shown in FIG. 6, an inner emission line corresponding to a convex array C1 is EO′, and an inner emission line corresponding to a convex array C2 is PO′.

The second arc is an arc located outside the first arc and defined by two convex arrays. In some embodiments, the second arc is determined by a virtual array determined by the two convex arrays. As shown in FIG. 6, an arc AO′M is the second arc. The second arc AO′M is located outside the first arc ABC and PQM.

In some embodiments, the virtual array refers to a virtual equivalent emission array formed by superposition of ultrasonic waves fields simultaneously emitted by the two convex arrays in space.

The target convex arrays refer to convex arrays symmetrically distributed on both sides of the linear array.

In some embodiments, the second arc is a projection of the virtual array determined by the two convex arrays on the plane (i.e., the reference plane).

For example, as shown in FIG. 6, C3 (FAO′M) is a virtual array formed when the two convex arrays C1 and C2 emit the ultrasonic waves. The projection AO′M of a surface of the virtual array on the plane (i.e., the reference plane) is the second arc.

In some embodiments, the center of the second arc is a geometric center of the virtual array, and a radius is the radius of the virtual array. A line connecting the center of the second arc and a midpoint of the line connecting geometric centers of the first arcs corresponding to the two convex arrays is perpendicular to a line connecting the geometric centers of the first arcs corresponding to the two convex arrays.

For example, as shown in FIG. 6, the center of the second arc AO′M is the geometric center F of the virtual array, and the radius is a radius r3 (i.e., FO′) of the virtual array. A line FT connecting the center F of the second arc and a midpoint T of a line DN connecting the geometric centers (D and N) of the first arcs corresponding to the two convex arrays is perpendicular to the line DN connecting the geometric centers (D and N) of the first arcs corresponding to the two convex arrays.

In some embodiments, the center of the second arc is determined based on a second extension angle.

The second extension angle is an opening angle of the virtual array. As shown in FIG. 6, θ is the second extension angle.

In some embodiments, the second extension angle may be preset manually based on clinical imaging requirements.

In some embodiments, the processor determines the center of the second arc based on the second extension angle. For example, the processor may determine an auxiliary angle based on the second extension angle, determine a radius of the second arc based on the auxiliary angle, and locate the center of the second arc based on the radius of the second arc. Specifically, the auxiliary angle is determined based on formula (5):

$$ϕ = ( θ - π ) / 2 \qquad ( 5 )$$

where, φ refers to the auxiliary angle, and θ refers to the second extension angle.

In some embodiments, the radius of the second arc is determined according to formula (6) as follows:

$${r}_{3} = \frac{{r}_{1} + \frac{dis 1}{2}}{cos ( φ )} , \qquad ( 6 )$$

where, φ refers to the auxiliary angle, r₁ refers to the physical radius of the convex array, and dis1 refers to a distance between the geometric centers (e.g., D and N in FIG. 6) of the two convex arrays (e. g., C1 and C2 in FIG. 6).

In some embodiments, the center of the second arc is determined according to formula (7) as follows:

$${L}_{F T} = {r}_{3} sin ( φ ) , \qquad ( 7 )$$

where L_{FT} refers to the length of a line segment (e.g., FT in FIG. 6) formed by connecting the center (e.g., F in FIG. 6) of the second arc and the midpoint (e.g., T in FIG. 6) of the geometric centers of the first arcs corresponding to the two convex arrays.

After the length of FT is determined, the center F of the second arc is located based on position coordinates of point T and the length of FT.

In some embodiments, after the auxiliary angle is determined based on the second extension angle, a first extension angle is further determined based on the auxiliary angle and the physical opening angle of the convex array. The value of the first extension angle β is: β=α+2φ, where α refers to the physical opening angle of the convex array, and (refers to the auxiliary angle.

In some embodiments of the present disclosure, a virtual array C3 is symmetric based on FT, i.e., C1 and C2 are symmetrically arranged based on the linear array, which can effectively reduce imaging skew and make coverage in an intermediate linear array interval area more uniform.

In some embodiments of the present disclosure, a processor accurately defines the first region by a plurality of boundaries including the first arc, the one or more inner emission lines, and the second arc. Then, the processor displays or does not display the first image corresponding to the second echo signals located in the first region in the reference display mode. The method can effectively remove noise in a near-field interference area of the convex array, avoid image distortion caused by clutter and side lobes, and make organ parenchyma, a puncture needle, and other effective tissue structures clearer in the image. Meanwhile, the method clearly defines a spatial boundary between an interference area (i.e., the first region) and an effective area (effective imaging area outside the first region), which helps quickly exclude the second echo signals in the interference area, reduces interference of this part of the image on diagnosis and treatment, and improves diagnostic efficiency and puncture positioning accuracy.

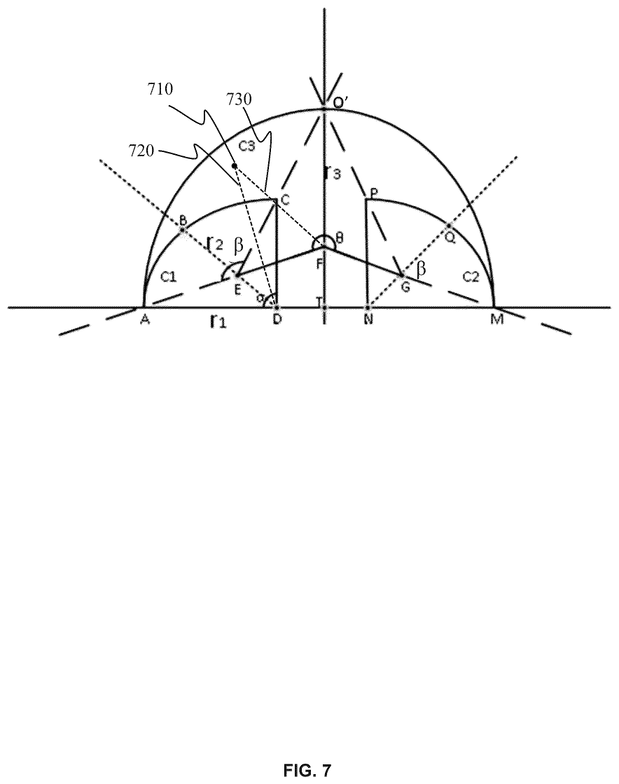

Whether a target echo signal is located in the first region is determined based on a first distance between the data position of the target echo signal and a geometric center of the first arc of a convex array, a second distance between the data position of the target echo signal and a center of the second arc, and the inner emission line corresponding to the convex array. For example, FIG. 7 is a schematic diagram illustrating determining whether a target echo signal is located in the first region according to some embodiments of the present disclosure.

As shown in FIG. 7, whether the target echo signal 710 is located in the first region is determined based on the first distance 720 between the target echo signal 710 and a geometric center E or G of the first arcs of two convex arrays, a second distance 730 between the target echo signal 710 and a center F of the second arc, and the inner emission lines corresponding to the convex arrays.

The first distance (e.g., the first distance 720) refers to a distance between a data position of the target echo signal and the geometric center of the first arc of one of the convex arrays.

The second distance (e.g., the second distance 730) refers to a distance between the data position of the target echo signal and the center of the second arc.

In some embodiments, the target echo signal being located in the first region needs to simultaneously satisfy the following three conditions:

Condition 1: The data position of the target echo signal is located outside the first arc (e.g., the first arc ABC of the convex array C1 as shown in FIG. 7).

In some embodiments, if the first distance 720 is greater than the physical radius r₁ of the convex array, it indicates that the data position is located outside the first arc ABC.

Condition 2: The data position of the target echo signal is located to the left of the inner emission line (e.g., inner emission line CO′ of the convex array C1 as shown in FIG. 7).

In some embodiments, a second coordinate system is established with point O′ in FIG. 7 as a coordinate origin, an X-axis is a line passing through O′ and parallel to AM, a Z-axis is TO′, an AM direction is a positive direction of X-axis and an O′T direction is a negative direction of Z-axis. If an X coordinate of the data position of the target echo signal is less than a range of X coordinate values of a line segment EO′, and a Z coordinate of the data position of the target echo signal is greater than a range of Z coordinate values of the line segment EO′, it may be determined that the target echo signal is located to the left of the inner emission line CO′ of C1.

Condition 3: The data position of the target echo signal is located inside the second arc (e.g., the second arc AO′M as shown in FIG. 7).

In some embodiments, if the second distance 730 is less than the radius r3 of the second arc, it indicates that the data position of the target echo signal is located inside the second arc AO′M.

In some embodiments, when the data position of the target echo signal satisfies the above three conditions simultaneously, the target echo signal is determined to be located in the first region. A determination process for the convex array C2 is similar, and details are not repeated here.

In some embodiments of the present disclosure, the processor accurately determines whether the target echo signal is located in the first region based on the first distance between the data position of the target echo signal and the center of the first arc, the second distance between the data position of the target echo signal and the center of the second arc, and its positional relationship relative to the inner emission line. By removing second echo signals in the first region where near-field interference such as side lobes and multiple reflections is concentrated, the influence of artifacts can be effectively reduced, and imaging of effective tissues, such as organ parenchyma and the puncture needle becomes clearer.

In some embodiments, the processor determines whether the data position of the target echo signal is located in a target range. If the data position of the target echo signal is not located in the target range, a value of the target echo signal may be set to 0. The echo signal set to 0 is invalid and does not participate in imaging or is not displayed after imaging.

The target range refers to a region range configured to define whether the second echo signal is effective, i.e., whether the second echo signal is to be used for ultrasound imaging. The second echo signal located in the target range is effective and is used for ultrasound imaging.

In some embodiments, the target range is set manually according to imaging requirements.

In some embodiments, the processor determines the target range based on the center of the second arc and the radius of the second arc.

In some embodiments, the processor first determines the data position of the target echo signal, and determines whether the target echo signal is located in the target range based on the data position of the target echo signal.

In some embodiments, if the data position of the target echo signal is in a coordinate system corresponding to the convex array, the processor converts the data position to a coordinate system corresponding to the virtual array to obtain a converted data position, and then determines whether the target echo signal is located in the target range based on the converted data position.

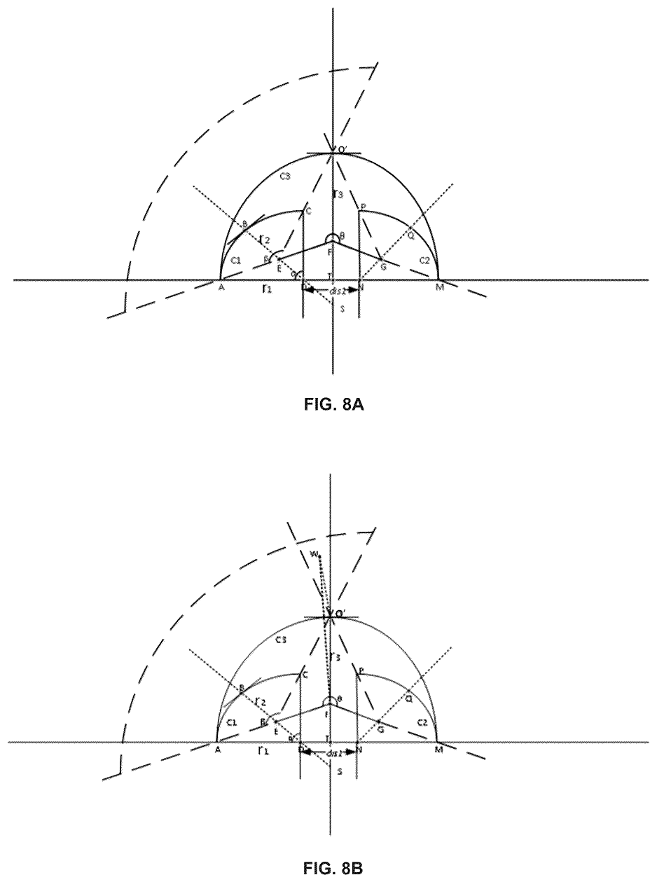

FIG. 8A is a schematic diagram illustrating an exemplary process for establishing a coordinate system according to some embodiments of the present disclosure.

FIG. 8B is a schematic diagram illustrating the determination of whether a target echo signal is valid according to some embodiments of the present disclosure.

In some embodiments, as shown in FIG. 8A, a first coordinate system is established with the midpoint B of the first arc ABC corresponding to the convex array C1 as a coordinate origin. An X-axis of the first coordinate system is a straight line where AM is located, and a Z-axis is a straight line parallel to FT and passing through point B. In some embodiments, a second coordinate system is established with the midpoint O′ of the second arc of the virtual array as a coordinate origin. An X-axis of the second coordinate system is a straight line parallel to AM and passing through point O′, and a Z-axis is a straight line where FT is located.

In some embodiments, the linear coordinate system and the second coordinate system are converted based on a geometric relationship. Coordinates of the origin B of the convex array coordinate system in the coordinate system corresponding to the virtual array are as shown in formula (8):

$$\{ \begin{matrix}{x}_{B} = {r}_{1} cos ( \frac{α}{2} ) + \frac{dis 1}{2} \\ {z}_{B} = - ( {r}_{3} + F T ) + {r}_{1} sin ( \frac{α}{2} )\end{matrix} \qquad ( 8 )$$

where, x_{B} is the X coordinate of point B in the coordinate system corresponding to the virtual array; z_{B} is the Z coordinate of point B in the coordinate system corresponding to the virtual array.

In some embodiments, a distance OB between an origin O and an origin B is determined by formula (9) as follows:

$$\vert OB \vert = \sqrt{{x}_{B}^{2} + {z}_{B}^{2}} \qquad ( 9 )$$

In some embodiments, based on the formula (8) and (9), a coordinate system conversion relationship between a convex array coordinate system and the coordinate system corresponding to the virtual array is determined by formula (10):

$$\vert \begin{matrix}{x}_{w}^{′} \\ {z}_{w}^{′} \\ 1\end{matrix} \vert = \vert \begin{matrix}1 & 0 & {x}_{B} \\ 0 & 1 & {z}_{B} \\ 0 & 0 & 1\end{matrix} \vert \vert \begin{matrix}cos γ & - sin γ & 0 \\ sin γ & cos γ & 0 \\ 0 & 0 & 1\end{matrix} \vert \vert \begin{matrix}{w}_{w} \\ {z}_{w} \\ 1\end{matrix} \vert \qquad ( 10 )$$

where

$$( {x}_{w}^{′} , {z}_{w}^{′} ) )$$

represents coordinates of the data position of the target echo signal W in FIG. 8B in a second coordinate system corresponding to the virtual array after coordinate conversion; (x_{w}, z_{w}) represents coordinates of the data position of the target echo signal W in a first coordinate system corresponding to the convex array; γ is an angle ∠DST between the coordinate origin B of the first coordinate system and an coordinate origin O′ of the second coordinate system, and a value of γ is:

$$γ = \frac{( π - α )}{2} .$$

In some embodiments, as shown in FIG. 8B, whether the target echo signal is located in the target range is determined based on the following two conditions.

Condition 1 is whether a distance from the data position of the target echo signal to an acoustic beam focus of a corresponding convex array is less than the sum of a radius of the third arc and a focusing depth during extended imaging of the convex array. For example, condition 1 is whether a distance from the data position of the target echo signal W to the acoustic beam focus E is less than (Depth+r₂), i.e., condition 1 is determined by formula (11):

$$\sqrt{{( {x}_{w}^{′} )}^{2} + {( {z}_{w}^{′} + {r}_{2} )}^{2}} < \vert Depth + {r}_{2} \vert \qquad ( 11 )$$

Condition 2 is whether an angle formed by the data position of the target echo signal, the acoustic beam focus of extended imaging of the corresponding convex array, and a midpoint of the third arc is within a third arc angle range of the convex array. For example, condition 2 is whether ∠ WEB is within

$$[ - \frac{β}{2} , \frac{β}{2} ] ,$$

where W, E, and B in ∠WEB represent the data position of the target echo signal W, an acoustic beam focus of the corresponding convex array, and the midpoint of the third arc, respectively. According to the law of cosines, condition 2 is determined by formula (11):

$$cos ( \frac{\vert W E {\vert}^{2} + \vert E B {\vert}^{2} - \vert W B {\vert}^{2}}{2 \vert W E \vert \vert E B \vert} ) = cos ( \frac{{( {y}_{w}^{′} + {r}_{2} )}^{2} + {r}_{2}^{2} + {( {y}_{w}^{′} )}^{2}}{2 {r}_{2} \sqrt{{( {x}_{w}^{′} )}^{2} + {( {y}_{w}^{′} + {r}_{2} )}^{2}}} ) > cos ( \frac{β}{2} ) \qquad ( 12 )$$

In some embodiments, if the target echo signal satisfies both condition 1 and condition 2, the target echo signal is located in the target range.

In some embodiments, a processor determines a first length based on data position (the converted data position) of the target echo signal W in the second coordinate system and a radius r₂ of a third arc corresponding to the convex array.

The first length describes the depth of the target echo signal, i.e., a distance between the target echo signal and a center F of the second arc.

As shown in FIG. 8B, W is the target echo signal, and WF is the first length.

In some embodiments, the processor determines the first length by the following formula (13):

$$the first length = \sqrt{{( {x}_{w}^{′} )}^{2} + {( {z}_{w}^{′} + {r}_{2} )}^{2}} \qquad ( 13 )$$

where

$${x}_{w}^{′}$$

represents a horizontal coordinate of the target echo signal in the second coordinate where, system,

$${z}_{w}^{′}$$

represents a vertical coordinate of the target echo signal in the second coordinate system, and r₂ represents the radius of the third arc corresponding to the convex array.

In some embodiments, the processor determines a second length based on the radius r₃ of a second arc corresponding to the virtual array and the focusing depth corresponding to the convex array.

For example, the second length=the radius r₃ of the virtual array+the focusing depth corresponding to the convex array.

In some embodiments, if the first length is less than the second length, the target echo signal is determined to be within the target range.

In this embodiment, when the processor detects that the first length is less than the second length, it indicates that the depth of the target echo signal is less than the second length. Therefore, the medical device determines that the target echo signal is within the target range.

In some embodiments, the processor performs ultrasound imaging based on the second echo signal within the target range to determine a second ultrasonic image.

The second region refers to an imaging region simultaneously covered by ultrasonic beams of two convex arrays on both sides of the linear array. In some embodiments, on a plane perpendicular to the axial direction (i.e., the reference plane), the second region is a sector region. In some embodiments, the second region is located 5-30 nm in front of the emission direction of an ultrasonic probe.

In some embodiments, the echo signals received by the two convex arrays overlap in the second region, i.e., the second region includes both an second echo signal received by the convex array C1 and an second echo signal received by the convex array C2.

In some embodiments, when the data position of the target echo signal in the second echo signal is located in the second region, the target echo signal and a complementary echo signal are fused to obtain fused data.

The complementary echo signal is an echo signal that has the same data position as the second target echo signal and is received by a different convexarray. For example, as shown in FIG. 6, in the second region, if the target echo signal is received by the convex array C1, the second echo signal received by the convex array C2 at the same data position as the target echo signal is the complementary echo signal.

A projection of the second region on the plane (i.e., the reference plane) is determined by inner emission lines of two convex arrays and is located outside the second arc, and an opening angle of the projection of the second region is determined based on a first extension angle of the convex arrays.

In some embodiments, as shown in FIG. 6, the projection of the second region 620 on the plane (i.e., the reference plane) is a region formed by intersection of the inner emission lines CO′ and PO′ of the two convex arrays C1 and C2, and the second region 620 is located outside the second arc AO′M.

The fused data refers to a fused echo signal obtained by performing signal fusion on a set of the target echo signal and the complementary echo signal received by different convex arrays.

In some embodiments, for the set of the target echo signal and the complementary echo signal received by different convex arrays at the same data position in the second region, the processor fuses them based on corresponding weights to obtain the fused data.

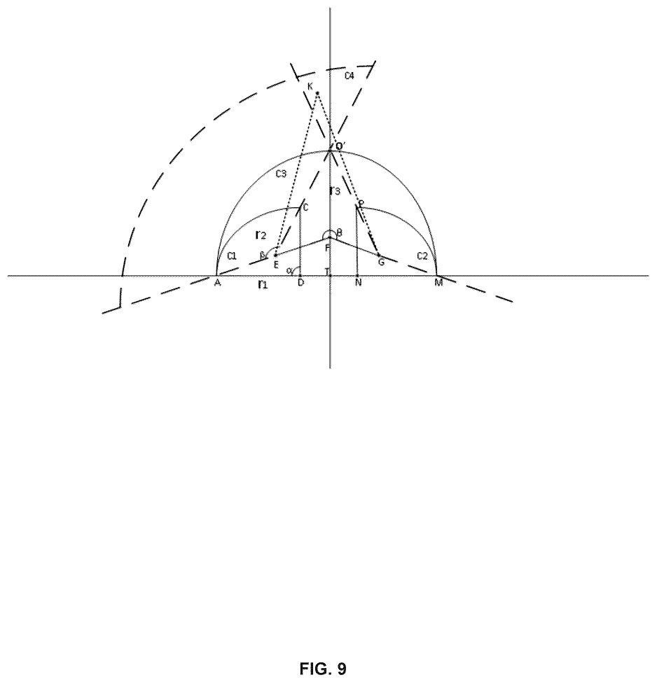

In some embodiments, the weights are preset according to requirements or set by system default. In some embodiments, the weights are also related to a distance between each of the second echo signals and the acoustic beam focus of the corresponding convex array, a tissue attenuation coefficient, an instantaneous signal-to-noise ratio, etc. More descriptions of how to determine the weights may be found in FIG. 9 and related descriptions.

In some embodiments, the processor displays a second image corresponding to the target echo signal located in the second region based on the fused data. In some embodiments, the processor performs ultrasound imaging based on the fused data, generates the second image corresponding to the target echo signal in the second region, and displays the second image.

In some embodiments of the present disclosure, the processor fuses the target echo signal and the complementary echo signal in the second region. Compared with selecting a second echo signal of only one convex array for imaging, fusing the echo signals of the two convex arrays improves a quality of the second echo signal in the second region, enhances the imaging quality at the edges of both the convex arrays, and improves the imaging quality in the central region of two convex arrays.

In some embodiments, the processor determines position coordinates and a second extension angle of the target echo signal in a coordinate system corresponding to a virtual array; determines a target angle based on the position coordinates of the target data in the coordinate system corresponding to the virtual array; and determines whether the target echo signal is located in the second region based on a first extension angle, the second extension angle, and the target angle.

More descriptions of the definition of the virtual array may be found in FIG. 6 and related descriptions. The coordinate system corresponding to the virtual array is the second coordinate system. More descriptions of the second coordinate system may be found in FIG. 8A-FIG. 8B and related descriptions.

More descriptions of the target echo signal and the first extension angle may be found in FIG. 4-FIG. 5 and related descriptions. More descriptions of the second extension angle may be found in FIG. 6 and related descriptions.

The position coordinates refer to coordinates of the data position of the target echo signal in the coordinate system corresponding to the virtual array (i.e., the second coordinate system).

In some embodiments, the position coordinates of the target echo signal in the coordinate system corresponding to the virtual array are determined by the formula (10), which is not repeated here.

The target angle refers to an angle between a coordinate of the data position of the target echo signal and a coordinate origin O′ of the second coordinate system in a coordinate system corresponding to a virtual array (i.e., the second coordinate system).

In some embodiments, the target angle may be determined based on the data position of the target echo signal through an arctangent function. For example, the target angle is calculated by the following formula (14):

$$μ = \vert arc tan ( \frac{{x}_{w}^{′}}{{z}_{w}^{′}} ) \vert \qquad ( 14 )$$

where, μ is an absolute value of the target angle, and

$$( {x}_{w}^{′} , {z}_{w}^{′} )$$

represents the position coordinates of the target echo signal W in the second coordinate system corresponding to the virtual array.

In some embodiments, the processor may compare a difference between a first extension angle and a preset multiple of a second extension angle with the absolute value of the target angle to determine whether the target echo signal is located in the second region. For example, the processor may compare the difference p between the first extension angle β and the preset multiple of the second extension angle θ with the absolute value u of the target angle to determine whether the target echo signal is located in the second region.

The preset multiple may be preset manually. For example, the preset multiple may be ½.

In some embodiments, when the difference is greater than the absolute value of the target angle, the target echo signal is determined to be in the second region. When the difference is less than or equal to the absolute value of the target angle, the target echo signal is determined not to be in the second region.

In some embodiments, the processor may also determine whether the data position of the target echo signal is located in the second region based on other methods. For example, the processor may first determine whether the data position of the target echo signal is within a target range, i.e., determine whether the target echo signal is valid. After determining that the target echo signal is valid, the processor may further determine, based on the data position of the target echo signal, whether the data position is located within an angle between inner emission lines of the two convex arrays and outside a second arc. If the data position also satisfies this condition, the target echo signal is located in the second region.

In some embodiments of the present disclosure, the processor determines whether the target echo signal is located in the second region based on the first extension angle, the second extension angle, and the target angle. This strategy may effectively eliminate invalid pixels generated by a probe dark area or an area outside a field of view, avoid interference from data in non-fusion regions, thereby ensuring validity of echo data in a fusion region, and improving continuity and stability of overall imaging.

FIG. 9 is a schematic diagram illustrating the determination of fusion weights based on distance according to some embodiments of the present disclosure.

In some embodiments, the processor determines a third distance between the data position of the target echo signal and a target acoustic beam focus; determines a fourth distance between the data position of the complementary echo signal and a complementary acoustic beam focus, the target acoustic beam focus being a focus of a transmit ultrasound beam corresponding to the target echo signal, and the complementary acoustic beam focus being a focus of a transmit ultrasound beam corresponding to the complementary echo signal; determines weights corresponding to the target echo signal and the complementary echo signal based on the third distance and the fourth distance; and fuses the target echo signal and the complementary echo signal based on the weights to obtain the fused data.

The target acoustic beam focus is a focus of the transmit ultrasound beam corresponding to the target echo signal. The complementary acoustic beam focus is a focus of the transmit ultrasound beam corresponding to the complementary echo signal. For example, as shown in FIG. 9, if the target echo signal is received by the convex array C1, the target acoustic beam focus is the acoustic beam focus E of the convex array C1. The complementary echo signal is received by the convex array C2, and the complementary acoustic beam focus of the complementary echo signal is the acoustic beam focus G of the convex array C2.

More descriptions of the target echo signal, the complementary echo signal, and the fused data may be found in the related descriptions above.

The third distance refers to a distance between the data position of the target echo signal and the target acoustic beam focus.

The fourth distance refers to a distance between the data position of the complementary echo signal and the complementary acoustic beam focus.

In some embodiments, as shown in FIG. 9, an echo signal received by the convex array C1 at the point K is the target echo signal, and an echo signal received by the convex array C2 at the point K is the complementary echo signal. The target acoustic beam focus is the point E, and the complementary acoustic beam focus is the point G. The third distance is a length of a line segment KE, and the fourth distance is a length of a line segment KG.

In some embodiments, an example in which the target echo signal is received by the convex array C1 and the complementary echo signal is received by the convex array C2 is used to illustrate how to determine respective weights corresponding to the target echo signal and the complementary echo signal. Merely by way of example, the processor may determine the respective weights corresponding to the target echo signal and the complementary echo signal through formula (15) based on the third distance and the fourth distance. The formula (15) is as follows:

$$\{ \begin{matrix}Q 1 = \frac{\vert K E {\vert}^{2}}{\vert K E {\vert}^{2} + \vert K G {\vert}^{2}} \\ Q 2 = \frac{\vert K G {\vert}^{2}}{\vert K E {\vert}^{2} + \vert K G {\vert}^{2}}\end{matrix} \qquad ( 15 )$$

where, Q1 is a weight of the target echo signal received by C1. Q2 is a weight of the complementary echo signal received by C2.

In some embodiments, the processor determines weights for fusing the target echo signal and the complementary echo signals based on at least one of a target distance, an instantaneous signal-to-noise ratio, a sound pressure distribution, an acoustic beam angle, or a tissue attenuation coefficient of a transmit ultrasound beam corresponding to each of the target echo signal and the complementary echo signals; and generates the second image based on the weights, the target echo signal, and the complementary echo signal.

The target distance refers to a distance from the data position of the target echo signal to a position of a corresponding acoustic beam focus. For example, the target distance corresponding to the target echo signal may be a distance between a corresponding data position and an acoustic beam focus corresponding to the convex array receiving the target echo signal. The target distance corresponding to the complementary echo signal is similar, and details are not repeated here. In some embodiments, the target distance may be KE or KG as shown in FIG. 9. How to determine the weight based on the target distance is similar to formula (15), and details are not repeated here.

The instantaneous signal-to-noise ratio refers to a ratio of a signal power to a noise power of an echo signal. The target echo signal and the complementary echo signal respectively correspond to the instantaneous signal-to-noise ratio.

In some embodiments, an echo signal with a larger instantaneous signal-to-noise ratio has a larger weight.

The sound pressure distribution refers to a sound pressure intensity distribution formed by a main lobe and various side lobes at different spatial positions in an emission sound field of an ultrasonic probe. In some embodiments, the sound pressure distribution is used to reflect reliability differences of echo signals at various points. A higher sound pressure indicates that a corresponding echo signal is more reliable.

In some embodiments, whichever of the target echo signal and the complementary echo signal corresponds to a higher sound pressure has a correspondingly larger weight.

The acoustic beam angle refers to an angle formed between a central axis of the transmit ultrasound beam of the convex array and a detection site or a detection surface.

In some embodiments, whichever of the target echo signal and the complementary echo signal corresponds to a larger acoustic beam angle has a correspondingly larger weight.

The tissue attenuation coefficient of the transmit ultrasound beam refers to a parameter of an energy attenuation degree when the transmit ultrasound beam propagates in different tissue paths. In some embodiments, a larger tissue attenuation coefficient indicates lower signal reliability. During fusion processing, the echo signal occupies a smaller weight.

In some embodiments, during fusion, one or more of the above factors affecting the weight may be selected based on actual requirements to determine a final weight used for echo signal fusion. If multiple influencing factors need to be considered, the processor may perform weighting or other suitable processing on weights determined based on the multiple influencing factors respectively to obtain a final weight used for the echo signal fusion.

In some embodiments of the present disclosure, the processor determines fusion weights based on at least one feature such as the target distance, the instantaneous signal-to-noise ratio, the sound pressure distribution, the acoustic beam angle, and the tissue attenuation coefficient, comprehensively considers various factors that may affect quality and reliability of echo signals, can determine more reasonable weights, improve accuracy of echo signal fusion, and provide an accurate and reliable data basis for imaging of an overlapping region of the two convex arrays.

In some embodiments, the processor preprocesses the target echo signal and the complementary echo signal of the convex arrays C1 and C2 at the same data position, and then determines fusion data through formula (16) based on the weight obtained by formula (15). More descriptions of the preprocessing may be found in step 230 and related descriptions.

$$P = Q 1 \cdot {P}_{1} + Q 2 \cdot {P}_{2} \qquad ( 16 )$$

where, P is fusion data; P1 is a target echo signal; P2 is a complementary echo signal.

In some embodiments of the present disclosure, a processor dynamically allocates a proportional coefficient through a distance of the acoustic beam focus, accurately balances sensitivity differences caused by process errors in two convex arrays, and avoids imaging faults in an overlapping area.

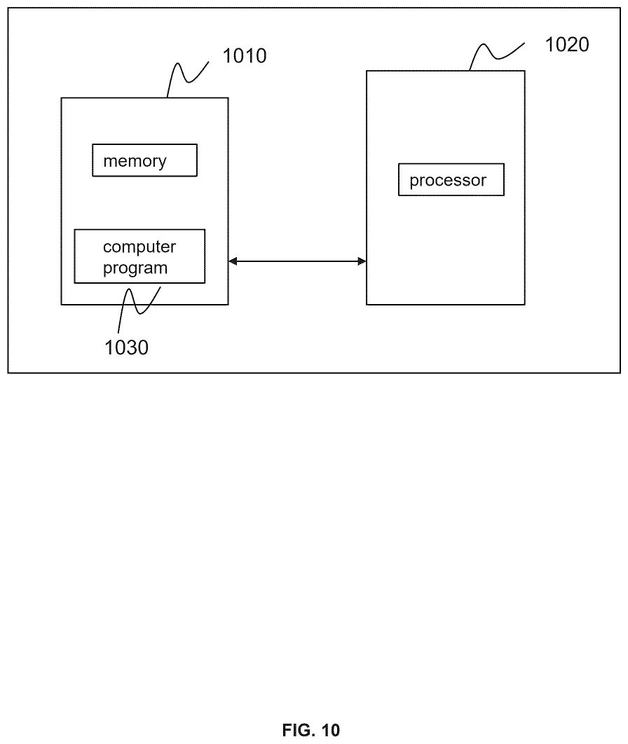

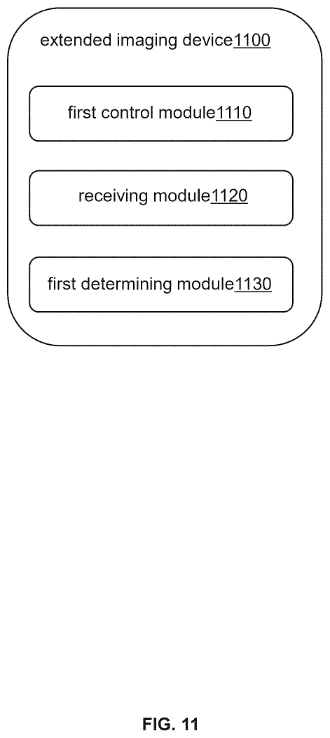

FIG. 10 is a schematic diagram illustrating a structure of an extended imaging system according to some embodiments of the present disclosure.

The extended imaging system 1000 may include a memory 1010, a processor 1020, and a computer program 1030. The computer program 1030 is stored in the memory 1010 and is executable on the processor 1020. When the processor 1020 executes the computer program 1030, steps in any extended imaging method shown in some embodiments of the present disclosure are implemented.

In some embodiments, the memory 1010 may be a read-only memory (ROM), a random access memory (RAM), a flash memory (Flash), or other non-transitory computer-readable storage media capable of storing computer instructions and data. In some embodiments, computer instructions for implementing an imaging processing flow of the present disclosure and related data may be stored in the memory 1010. The computer instructions may include an instruction set for receiving an echo signal, determining a data position, determining a display mode, and constructing an image, etc.

The processor 1020 is configured to execute the computer program stored in the memory to complete processing of multi-array ultrasonic echo signals and image reconstruction. The processor may be a general-purpose processor (e.g., a CPU), a dedicated digital signal processor (DSP), an image processor (GPU), a microcontroller (MCU), a programmable logic device (e.g., an FPGA), or other computing hardware capable of executing instructions. A person skilled in the art may select an appropriate processor type according to system performance requirements. In some embodiments, the processor 1020 is configured to execute the computer instructions stored in the memory 1010 to implement steps of an extended imaging method: receiving echo signals, wherein the echo signals include first echo signals and second echo signals, and the first echo signals and the second echo signals are generated based on ultrasonic waves transmitted by elements on a linear array of an ultrasonic probe and elements on two convex arrays of the ultrasonic probe, respectively; for each of the second echo signals, determining a display mode based on a corresponding data position, the data position being a projection position of the second echo signals on a plane perpendicular to an axial direction, wherein the axial direction being a direction in which the ultrasonic probe extends into a detection site of a subject; and displaying, based on the display mode corresponding to each of at least portion of the echo signals, one or more ultrasonic images generated based on the at least portion of the echo signals.

In some embodiments, the processor 1020 is configured to simultaneously display the first ultrasonic image and the second ultrasonic image, wherein the first ultrasonic image is obtained based on at least one of first echo signals received by the linear array, the second ultrasonic image is obtained based on at least one of second echo signals received by the convex arrays, and the first ultrasonic image and the second ultrasonic image synchronously reflect a slice of the detection site parallel to and a slice perpendicular to the axial direction, respectively.

In some embodiments, the processor 1020 is configured to, in response to determining that a data position of a target echo signal in the second echo signal is located in a first region, display a first image corresponding to the target echo signal in a reference display mode or not display the first image; wherein the target echo signal is one of the echo signals, the first region is a region adjacent to a surface of the convex arrays.

In some embodiments, the processor 1020 is configured to, when a data position of a target echo signal in the second echo signals is located in a second area, perform fusion on the target echo signal and a complementary echo signal to determine a second image, the complementary echo signal being an echo signal is same as the data position of the target echo signal and received by a different convex array; the second area is at least a portion of an imaging area commonly covered by two convex arrays located on two sides of the linear array.

The computer program 1030 is stored in the memory 1010 and may be implemented in, for example, a form of an instruction set, a modular program, a function library, or firmware. In some embodiments, when the processor 1020 executes the computer program 1030, steps in any extended imaging method shown in some embodiments of the present disclosure may be implemented.

FIG. 11 is a block diagram illustrating exemplary units of an extended imaging device according to some embodiments of the present disclosure.

For ease of explanation, only portions relevant to the embodiments of the present disclosure are illustrated. Referring to FIG. 11, the extended imaging device 1100 includes a first control module 1110, a receiving module 1120, and a first determining module 130.

The first control module 1110 is configured to control an ultrasonic probe to generate transmit ultrasound beams in different emission directions and transmit ultrasonic waves toward a detection site of a subject in response to an imaging instruction. More descriptions of the ultrasonic probe and the transmit ultrasonic waves may be found in FIGS. 2-3 and related descriptions.

The receiving module 1120 is configured to receive echo signals.

The first determining module 1130 is configured to determine an ultrasonic image based on the echo signals.

In some embodiments, the first control module 1110 includes a first calculation unit, a second calculation unit, a third calculation unit, and a second control unit.

The first calculation unit is configured to calculate, based on a reference number of transmit ultrasound beams and a first extension angle, extension sub-angles corresponding to different emission directions for the transmit ultrasound beams of each convex array.

The second calculation unit is configured to calculate, based on an acoustic beam focus corresponding to each convex array and the extension sub-angles, first positions of respective elements of each convex array.

The third calculation unit is configured to calculate, based on the extension sub-angles corresponding to each convex array and the acoustic beam focus of each convex array, focus coordinates of transmit ultrasound beams in different emission directions corresponding to each convex array.

The second control unit is configured to control the elements on at least two second arrays of the ultrasonic probe to transmit ultrasonic waves toward the detection site of a subject based on the first positions and the focus coordinates corresponding to each convex array.

In some embodiments, the third calculation unit includes a fourth calculation sub-unit and a fifth calculation sub-unit.

The fourth calculation sub-unit is configured to calculate, for any one of the convex arrays, a radius of a third arc based on the beam focus corresponding to the convex array, the first extension angle, and a physical opening angle. The geometric center of the third arc is the acoustic beam focus.

The fifth calculation sub-unit is configured to calculate, based on a focusing depth, the radius of the third arc, and the extension sub-angles corresponding to the convex array, the focus coordinates of transmit ultrasound beams in different emission directions corresponding to the convex array.

In some embodiments, the second echo signals include multiple echo signals. The first determining module 1130 includes a second determining unit, a deletion unit, and a processing unit.

The second determining unit is configured to determine a data position of each second echo signal. In some embodiments, the data position includes a position of the second echo signal in a first coordinate system corresponding to the convex array, and a position converted to a second coordinate system corresponding to a virtual array.

The deletion unit is configured to delete a target echo signal when the data position of the target echo signal is not within a target range. The target echo signal is any one of the multiple second echo signals.

The processing unit is configured to perform signal processing on remaining second echo signals to generate an ultrasonic image, the remaining second echo signals being the second echo signals other than the target echo signals.

In some embodiments, the extended imaging device 1100 further includes a third determining module, a sixth calculation module, and a construction module.

The third determining module is configured to determine a distance between geometric centers of the first arcs respectively corresponding to two convex arrays.

The sixth calculation module is configured to calculate, based on the distance between the geometric centers of the first arcs corresponding to the two convex arrays, the radius of the first arcs, and a second extension angle, a radius of a second arc corresponding to the virtual array.

The construction module is configured to determine the target range based on a radius of the second arc and a geometric center of the second arc.

In some embodiments, the extended imaging device 1100 further includes a conversion module, a seventh calculation module, an eighth calculation module, and a fourth determining module.

The conversion module is configured to convert the data position of a target echo signal from the first coordinate system corresponding to the convex array into the second coordinate system corresponding to the virtual array, when the data position is under the first coordinate system of the convex array.

The seventh calculation module is configured to calculate a first length based on the data position of the target echo signal in the second coordinate system and the radius of the third arc corresponding to the convex array.

The eighth calculation module is configured to calculate a second length based on the radius of the second arc corresponding to the virtual array and a focusing depth corresponding to the convex array.

The fourth determining module is configured to determine that the target echo signal is within the target range when the first length is less than the second length.

In some embodiments, the extended imaging device 1100 further includes a detection module, an acquisition module, a fifth determining module, a ninth calculation module, and a fusion module.

The acquisition module is configured to acquire a complementary echo signal corresponding to the target echo signal when the target echo signal is within a second region.

The fifth determining module is configured to determine a third distance between the target echo signal and a target acoustic beam focus, and determine a fourth distance between the complementary echo signal and a complementary acoustic beam focus. The target acoustic beam focus is the focus of the transmit ultrasound beams corresponding to the target echo signal, and the complementary acoustic beam focus is the focus of the transmit ultrasound beams corresponding to the complementary echo signal.

The ninth calculation module is configured to determine weights respectively corresponding to the target echo signal and the complementary echo signal based on the third distance and the fourth distance.

The fusion module is configured to fuse the target echo signals and the complementary echo signals based on the weights to obtain fused data.

In some embodiments, the detection module includes a sixth determining unit, a tenth calculation unit, a seventh determining unit, and an eighth determining unit.

The sixth determining unit is configured to determine the data position of the target echo signal in the second coordinate system corresponding to the virtual array, and determine a second extension angle corresponding to the virtual array.

The tenth calculation unit is configured to calculate a target angle based on an arctangent function applied to the data position of the target echo signal in the second coordinate system corresponding to the virtual array.

The seventh determining unit is configured to determine that the target echo signal is within the second region when a difference between the first extension angle and a preset multiple of the second extension angle is greater than an absolute value of the target angle.

The eighth determining unit is configured to determine that the target echo signal is not within the second region when the difference is less than or equal to the absolute value.

It should be noted that information interaction and execution processes among the above modules/units are based on the same inventive concept as the method embodiments of the present application. Their specific functions and technical effects may be found in some embodiments and thus are not repeated here.

A person skilled in the art will understand that, for the sake of convenience and clarity, the divisions of the above functional units and modules are merely illustrative. In actual applications, the above functions may be implemented by different units or modules as needed; that is, the internal structure of the device may be divided into different functional units or modules to implement all or part of the above functions. The specific names of the units and modules are merely for mutual distinction and do not limit the scope of protection of the present application. The specific working processes of the units and modules in the system may refer to the corresponding processes in the method embodiments and are not repeated here.

The basic concepts have been described above. Obviously, to a person skilled in the art, the above detailed disclosure is merely an example and does not constitute a limitation to the present disclosure. Although not explicitly stated herein, a person skilled in the art may make various modifications, improvements, and amendments to the present disclosure. Such modifications, improvements, and amendments are suggested in the present disclosure, so they still fall within the spirit and scope of the exemplary embodiments of the present disclosure.

Meanwhile, the present disclosure uses specific words to describe the embodiments of the present disclosure. For example, “one embodiment,” “an embodiment,” and/or “some embodiments” mean that a certain feature, structure, or characteristic is related to at least one embodiment of the present disclosure. Therefore, it should be emphasized and noted that “an embodiment” or “one embodiment” or “an alternative embodiment” mentioned two or more times in different places in the present disclosure does not necessarily refer to the same embodiment. In addition, certain features, structures, or characteristics in one or more embodiments of the present disclosure may be appropriately combined.

In addition, unless explicitly stated in the claims, the order of processing elements and sequences, the use of numbers and letters, or the use of other names in the present disclosure are not used to limit the order of the processes and methods of the present disclosure. Although the foregoing disclosure discusses some currently considered useful inventive embodiments through various examples, it should be understood that such details are for illustrative purposes only, and the appended claims are not limited to the disclosed embodiments. Instead, the claims are intended to cover all modifications and equivalent combinations that conform to the essence and scope of the embodiments of the present disclosure. For example, although the implementation of various components described above may be embodied in a hardware device, it may also be implemented as a software only solution, e.g., an installation on an existing server or mobile device.

Similarly, it should be noted that, in order to simplify the expression disclosed in the present disclosure and thereby help the understanding of one or more inventive embodiments, in the foregoing description of the embodiments of the present disclosure, various features are sometimes grouped into one embodiment, drawing, or description thereof. However, this disclosure method does not mean that the object of the present disclosure requires more features than those mentioned in the claims. Rather, claimed subject matter may lie in less than all features of a single foregoing disclosed embodiment.

In some embodiments, numbers describing components and attribute quantities are used. It should be understood that such numbers used to describe the embodiments are modified by the modifiers “approximately,” “approximate,” or “substantially” in some examples. Unless otherwise stated, “approximately,” “approximate,” or “substantially” indicates that the stated number allows a variation of ±20%. Accordingly, in some embodiments, the numerical parameters used in the specification and claims are approximate values, which may vary according to the required characteristics of individual embodiments. In some embodiments, numerical parameters should consider the specified number of significant digits and adopt the method of general digit retention. Although the numerical ranges and parameters used to confirm the breadth of the scope in some embodiments of the present disclosure are approximate values, in specific embodiments, the setting of such numerical values is as accurate as possible within a feasible range.

For each patent, patent application, patent application publication, and other materials, such as articles, books, specifications, publications, documents, etc., cited in the present disclosure, the entire contents thereof are hereby incorporated into the present disclosure by reference. Except for application history documents that are inconsistent with or conflict with the content of the present disclosure, and documents that limit the broadest scope of the claims of the present disclosure (currently or later attached to the present disclosure) are also excluded. It should be noted that if the description, definition, and/or use of terms in the ancillary materials of the present disclosure are inconsistent with or conflict with the content described in the present disclosure, the description, definition, and/or use of terms in the present disclosure shall prevail.

Finally, it should be understood that the embodiments described in the present disclosure are only used to illustrate the principles of the embodiments of the present disclosure. Other variations may also fall within the scope of the present disclosure. Therefore, by way of example and not limitation, alternative configurations of the embodiments of the present disclosure may be considered consistent with the teachings of the present disclosure. Accordingly, the embodiments of the present disclosure are not limited to the embodiments explicitly introduced and described in the present disclosure.

What is claimed is:

1. An extended imaging method, comprising:
receiving echo signals, wherein the echo signals include first echo signals and second echo signals, the first echo signals are generated based on ultrasonic waves transmitted by elements on a linear array of an ultrasonic probe, and the second echo signals are generated based on ultrasonic waves transmitted by elements of two convex arrays of the ultrasonic probe;
for each second echo signal of at least a portion of the second echo signals, determining a display mode based on a corresponding data position of the second echo signal, the data position being a projection position of the second echo signal on a plane perpendicular to an axial direction, wherein the axial direction is a direction in which the ultrasonic probe extends into a detection site of a subject; and
displaying, based on the display mode corresponding to each of at least portion of the second echo signals, one or more ultrasonic images generated based on the at least portion of the second echo signals.

2. The method according to claim 1, wherein the two convex arrays are located on two sides of the linear array, the elements on the linear array are distributed along the axial direction, the elements on the convex arrays are distributed along a direction perpendicular to the axial direction, and a projection of each of the convex arrays on a plane perpendicular to the axial direction is a first arc.

3. The method according to claim 1, wherein the one or more ultrasonic images include a second ultrasonic image, the method further comprising:
simultaneously displaying a first ultrasonic image and the second ultrasonic image, wherein the first ultrasonic image is generated based on at least one of the first echo signals, the second ultrasonic image is generated based on at least one of the second echo signals, and
the first ultrasonic image is a slice of the detection site parallel to the axial direction and the second ultrasonic image is a slice of the detection site perpendicular to the axial direction.

4. The method according to claim 1, wherein the display mode includes a reference display mode and non-display, and the displaying, based on the display mode corresponding to each of at least portion of the second echo signals, one or more ultrasonic images generated based on the at least portion of the second echo signals comprises:
in response to determining that a data position of at least one target echo signal in the second echo signals is located in a first region, displaying a first image corresponding to the at least one target echo signal in a reference display mode or not displaying the first image, wherein the first region is a region adjacent to a surface of the convex arrays.

5. The method according to claim 1, wherein displaying, based on the display mode corresponding to each of at least portion of the second echo signals, one or more ultrasonic images generated based on the at least portion of the second echo signals comprises:
in response to determining that a data position of a target echo signal in the second echo signals is located in a second region, determining a second image by fusing the target echo signal and complementary echo signals, wherein data positions of the complementary echo signals are the same as the data position of the target echo signal and the complementary echo signals are received by the two convex arrays;
the second region is at least a portion of an imaging region and is covered by the two convex arrays located on the two sides of the linear array.

6. The method according to claim 5, wherein the determining a second image by fusing the target echo signal and complementary echo signals comprises:
determining weights for fusing the target echo signal and the complementary echo signals based on at least one of a target distance, an instantaneous signal-to-noise ratio, a sound pressure distribution, an acoustic beam angle, or a tissue attenuation coefficient of a transmit ultrasound beam corresponding to each of the target echo signal and the complementary echo signals; and
generating the second image based on the weights, the target echo signal, and the complementary echo signals.

7. The method according to claim 1, wherein an emission direction of elements in each of the two convex arrays is a direction of a transmit ultrasound beam from an acoustic beam focus outward, and the acoustic beam focus is closer to the each of the at convex arrays than a geometric center of a first arc.

8. The method according to claim 7, wherein the acoustic beam focus is a geometric center of a third arc corresponding to each of the convex arrays, the third arc is a virtual arc when the convex array transmits acoustic waves, and the acoustic beam focus is located on a line connecting the geometric center of the first arc and a midpoint of the first arc;
the acoustic beam focus is determined based on a first extension angle of each of the convex arrays, the first extension angle being an angle for extended imaging based on the convex array.

9. The method according to claim 7, further comprising:
in response to determining that a data position of a target echo signal in the second echo signals is located in a first region, displaying a first image corresponding to the target echo signal in a reference display mode or not displaying the first image;
wherein a projection of the first region on the plane is a region bounded by the first arc, an inner emission line, and a second arc, the inner emission line being a centerline of a projection on the plane of a transmit ultrasound beam, from the two convex arrays, that is most biased toward the linear array, the second arc is an arc located outside the first arc and defined by two convex arrays, and the two convex arrays are located on the two sides of the linear array.

10. The method according to claim 8, wherein
the second arc is a projection on the plane of a virtual array determined based on the two convex arrays, a center of the second arc is a geometric center of the virtual array, and a radius of the second arc is a radius of the virtual array;
a line connecting the center of the second arc and a midpoint of a line connecting geometric centers of the first arcs corresponding to the two convex arrays is perpendicular to a line connecting the geometric centers of the first arcs corresponding to the two convex arrays.

11. The method according to claim 10, wherein the center of the second arc is determined based on a second extension angle, the second extension angle being an opening angle of the virtual array.

12. The method according to claim 9, wherein whether the target echo signal is located in the first region is determined based on a first distance between a data position of the target echo signal and the geometric center of the first arc of a convex array, a second distance between the data position of the target echo signal and the center of the second arc, and the inner emission line corresponding to the convex array.

13. The method according to claim 7, further comprising:
in response to determining that a data position of a target echo signal in the second echo signals is in a coordinate system corresponding to the convex arrays, transforming the data position into a coordinate system corresponding to a virtual array to obtain a transformed data position;
determining whether the target echo signal is located within a target range based on the transformed data position;
in response to determining that the target echo signal is not located within the target range, determining that the target echo signal is invalid; and
in response to determining that the target echo signal is located within the target range, performing ultrasound imaging based on the target echo signal.

14. The method according to claim 13, wherein determining whether the target echo signal is located within the target range based on the transformed data position comprises:
determining a first length based on the transformed data position and a radius of a third arc of the convex array that receives the target echo signal;
determining a second length based on a radius of a second arc corresponding to the virtual array and a focusing depth corresponding to the convex array that receives the target echo signal; and
determining that the target echo signal is located within the target range when the first length is smaller than the second length.

15. The method according to claim 7, further comprising:
in response to determining that a data position of a target echo signal in the second echo signal is located in a second region, determining a fused echo signal by fusing the target echo signal and a complementary echo signal, wherein a data position of the complementary echo signal corresponds to the data position of the target echo signal and the complementary echo signal is received by a different convex array of the two convex arrays; wherein a projection of the second region on the plane is determined by inner emission lines of two convex arrays and is located outside the second arc, an opening angle of the projection of the second region is determined based on a first extension angle of the convex arrays,
displaying a second image based on the fused echo signal.

16. The method according to claim 15, wherein the determining a fused echo signal by fusing the target echo signal and one or more complementary echo signals comprises:
determining a third distance between a data position of the target echo signal and a target acoustic beam focus; determining a fourth distance between a data position of the complementary echo signal and a complementary acoustic beam focus, the target acoustic beam focus being a focus of a transmit ultrasound beam corresponding to the target echo signal, and the complementary acoustic beam focus being a focus of a transmit ultrasound beam corresponding to the complementary echo signal;
determining weights corresponding to the target echo signal and the complementary echo signal based on the third distance and the fourth distance; and
fusing the target echo signal and the complementary echo signal based on the weights to obtain the fused data.

17. The method according to claim 15, further comprising:
determining position coordinates and a second extension angle of the target echo signal in a coordinate system corresponding to a virtual array;
determining a target angle based on the position coordinates of the target data in the coordinate system corresponding to the virtual array; and
determining whether the target echo signal is located in the second region based on a first extension angle, the second extension angle, and the target angle.

18. The method according to claim 1, further comprising:
determining, based on a reference number of transmit ultrasound beams and a first extension angle, extension sub-angles each of which corresponds to one of different emission directions corresponding to each of the two convex arrays;
determining, based on an acoustic beam focus corresponding to each of the two convex arrays and the extension sub-angles, a first position of each element of each of the two convex arrays;
determining, based on the extension sub-angles and the acoustic beam focus corresponding to each of the two convex arrays, focus coordinates of transmit ultrasound beams for the different emission directions corresponding to each of the t two convex arrays; and
controlling the elements on the two convex arrays of the ultrasonic probe to transmit the ultrasonic waves toward the detection site based on the first position and the focus coordinates corresponding to each of the two second arrays.

19. The method according to claim 15, wherein the determining, based on the extension sub-angles and the acoustic beam focus corresponding to each of the two convex arrays, focus coordinates of transmit ultrasound beams for the different emission directions corresponding to each of the two convex arrays comprises:
for any one of the two convex arrays, acquiring a focusing depth corresponding to the convex array; and
determining the focus coordinates of the transmit ultrasound beams for the different emission directions corresponding to the convex array based on the focusing depth, the radius of the third arc, and the extension sub-angles corresponding to the convex array.

20. An extended imaging system, comprising:
at least one storage medium including a set of instructions; and
at least one processor in communication with the at least one storage medium, wherein when executing the set of instructions, the at least one processor is directed to cause the system to perform operations including:
receiving echo signals, wherein the echo signals include first echo signals and second echo signals, and the first echo signals and the second echo signals are generated based on ultrasonic waves transmitted by elements on a linear array of an ultrasonic probe and elements on two convex arrays of the ultrasonic probe, respectively;
for each of the second echo signals, determining a display mode based on a corresponding data position, the data position being a projection position of the second echo signals on a plane perpendicular to an axial direction, wherein the axial direction being a direction in which the ultrasonic probe extends into a detection site of a subject; and
displaying, based on the display mode corresponding to each of at least portion of the echo signals, one or more ultrasonic images generated based on the at least portion of the echo signals.
